(19) United States
(12) Patent Application Publication
(10) Pub. No.: US 2026/0142859 A1
(43) Pub. Date: May 21, 2026

(54) COMMUNICATION METHOD AND COMMUNICATION APPARATUS

(71) Applicant: Huawei Technologies Co., Ltd., Shenzhen (CN)

(72) Inventors: Wuxian Shi, Ottawa (CA); Yiqun Ge, Ottawa (CA); Jianglei Ma, Ottawa (CA); Xiaoyan Bi, Shanghai (CN)

(21) Appl. No.: 19/393,198

(22) Filed: Nov. 18, 2025

Related U.S. Application Data
(63) Continuation of application No. PCT/CN2023/109913, filed on Jul. 28, 2023.
(60) Provisional application No. 63/503,277, filed on May 19, 2023.

(51) Int. Cl. H04L 27/26; H04W 72/044

(52) U.S. Cl. CPC H04L 27/261; H04W 72/044

(57) ABSTRACT

Embodiments of the present application provide a communication method and communication apparatus. The method includes: generating a first sequence of reference signals; mapping the first sequence to M frequency domain resource units on K antenna ports, M positions of the M frequency domain resource units being indicated by a second sequence; where the second sequence is generated based on a first parameter set, and M and K are positive integers, M≥K.

### CROSS-REFERENCE TO RELATED APPLICATIONS

This application is a continuation of International Application No. PCT/CN2023/109913, filed on Jul. 28, 2023, which claims priority to U.S. Patent Application No. 63/503,277, filed on May 19, 2023. All of the aforementioned patent applications are hereby incorporated by reference in their entireties.

### TECHNICAL FIELD

Embodiments of the present application relate to the field of communication, and more specifically, to a communication method and communication apparatus.

### BACKGROUND

In a wireless communication system, reference signals can be transmitted between a transmitting apparatus and a receiving apparatus for channel estimation. A transmitting apparatus transmitting reference signals may map a sequence of reference signals to a certain physical resource, which may be referred to as a reference signal resource. The position of reference signal resources is known to both the transmitting apparatus and the receiving apparatus receiving the reference signals. The position of reference signals may be referred to as a reference signal pattern. The receiving apparatus can perform channel estimation based on the received reference signals.

In current wireless communication systems, antenna ports for reference signals and the positions of the time-frequency domain resources associated with each antenna port are predefined. However, as communication systems evolve, this predefined way of assigning resources may not be applicable or may be problematic. For example, the increased number of antenna ports supported for reference signals transmission in more current systems, may result in a large number of resources being predefined for the reference signals.

Therefore, how to determine reference signal patterns becomes an urgent problem to be solved.

### SUMMARY

Embodiments of the present application provide a communication method and communication apparatus. The technical solutions may make the process of determining a reference signal pattern more flexible.

According to a first aspect, an embodiment of the present application provides a communication method, and the method could be performed by a transmitting apparatus. The method includes: generating a first sequence of reference signals; mapping the first sequence to M frequency domain resource units on K antenna ports, M positions of the M frequency domain resource units being indicated by a second sequence; where the second sequence is generated at least based on a first parameter set and a third sequence, and M and K are positive integers, M≥K.

According to a second aspect, an embodiment of the present application provides a communication method, and the method could be performed by a receiving apparatus. The method includes: receiving reference signals, a first sequence of the reference signals being mapped to M frequency domain resource units on K antenna ports, M positions of the M frequency domain resource units being indicated by a second sequence; where the second sequence is generated at least based on a first parameter set and a third sequence, and M and K are positive integers, M≥K.

In this application, the transmitting apparatus could determine M positions of the M frequency domain resource units by determining the second sequence, and associate the M frequency domain resource units to the K antenna ports. The second sequence is generated at least based on a first parameter set and a third sequence, that is, in contrast to predefining positions of frequency domain resource units for the reference signals. The second sequence generated based on the first parameter set makes the process of determining a reference signal pattern more flexible.

With reference to the first aspect or the second aspect, in some embodiments, the first parameter set comprises one or more of the following parameters: an identifier of a terminal device; a density of the reference signals; a size of a bandwidth, wherein the bandwidth comprises the M frequency domain resource units; a position of the bandwidth; a communication environment parameter; time domain information to indicate one or more time domain resource unit associated with the M frequency domain resource units; and spatial domain information to indicate P antenna ports supported for the reference signals transmission, where P is a positive integer.

In this application, a first parameter set could be used to determine the second sequence, for example, a length of the second sequence or sequence values in the second sequence could be determined based on the first parameter set. In other words, the transmitting apparatus could generate the second sequence considering a variety of parameters, to determine the positions of frequency domain resource units of reference signals, and a way to flexibly determine resources is provided.

With reference to the first aspect or the second aspect, in some embodiments, the method further includes: transmitting or receiving one or more of parameters in the first parameter set.

In this application, all or part of parameters in the first parameter set (some parameters in the first parameter set may not be transferred if e.g. the transmitting apparatus and the receiving apparatus both know they can not be transferred) can be transferred between a transmitting apparatus and a receiving apparatus (which receives reference signals), so that the transmitting apparatus and the receiving apparatus can obtain the same reference signal pattern based on the first parameter set, and the transmission resource consumption used to indicate reference signal pattern can be reduced.

With reference to the first aspect or the second aspect, in some embodiments, sequence values in the third sequence are selected from a value range, a ratio of the j-th sequence value in the third sequence to a size of the value range is related to a ratio of the j-th sequence value in the second sequence to the number of frequency domain resource units in bandwidth, and the bandwidth comprises the M frequency domain resource units.

In this application, ratios of sequence values in the third sequence to the size of the value range could reflect a value distribution characteristic. Ratios of sequence values in the second sequence to the number of frequency domain resource units in the bandwidth could reflect a distribution characteristic of the M positions of the M frequency domain resource units, that is, the distribution characteristic of the M positions of the M frequency domain resource units could be determined based on the third sequence. The distribution characteristic of the M positions of the M frequency domain resource units could be designed flexibly.

With reference to the first aspect or the second aspect, in some embodiments, the third sequence comprises T subsequences, the T subsequences of the third sequence are associated with T time domain resource units, the M frequency domain resource units are divided into T frequency domain resource groups based on the T subsequences of the third sequence, the T time domain resource units are associated with the T frequency domain resource groups, respectively, and T is a positive integer.

In this application, the property that sequence values are arranged in a certain order is utilized, a certain time domain resource unit may be associated with some sequence values at certain positions. The positions of sequence values in the third sequence could be used to determine the association relationship between the M frequency domain resource units and the one or more time domain resource units, and the complexity of designing of reference signal patterns is reduced.

With reference to the first aspect or the second aspect, in some embodiments, the third sequence comprises K subsequences, the K subsequences of the third sequence are associated with the K antenna ports, the M frequency domain resource units are divided into K frequency domain resource groups based on the K subsequences of the third sequence, and the K antenna ports are associated with the K frequency domain resource groups, respectively.

In this application, the property that sequence values are arranged in a certain order is utilized, a certain antenna port may be associated with some sequence values at certain positions. The positions of sequence values in the third sequence could be used to determine the association relationship between the M frequency domain resource units and the K antenna ports, and the complexity of designing of reference signal pattern is reduced.

With reference to the first aspect or the second aspect, in some embodiments, the second sequence generated at least based on a first parameter set and the third sequence comprises: the second sequence has a first relationship with the first parameter set and the third sequence, and the first relationship is determined at least based on a second parameter set, and the second parameter set comprise one or more of the following parameters: an identifier of a terminal device; a first relationship type parameter to indicate a type of the first relationship; a first relationship index to identify the first relationship; a density of the reference signals; a size of bandwidth, wherein the bandwidth comprises the M frequency domain resource units; a position of the bandwidth; a communication environment parameter; time domain information to indicate one or more time domain resource units associated with the M frequency domain resource units; and spatial domain information to indicate P antenna ports supported for the reference signals transmission, P is a positive integer.

In this application, there is a first relationship between the second sequence, the third sequence and the first parameter set. For example, in some embodiments, the second sequence, the third sequence and the first parameter set could meet a first function, and the first function could be determined based on a second parameter set. For example, multiple first functions could be used to generate a second sequence, and at least one function could be selected from the multiple functions based on the second parameter set. Thus, more flexible way to determine reference signal patterns is provided.

With reference to the first aspect or the second aspect, in some embodiments, the method further comprises: transmitting or receiving one or more the parameters in the second parameter set.

In this application, all or part of parameters in the second parameter set (some parameters in the first parameter set may not be transferred if e.g. the transmitting apparatus and the receiving apparatus both know they can not be transferred) can transferred between a transmitting apparatus and a receiving apparatus, so that the transmitting apparatus and the receiving apparatus can determine a same relationship based on the second parameter set, and the transmission resource consumption used to indicate reference signal pattern can be reduced.

With reference to the first aspect or the second aspect, in some embodiments, the third sequence is determined at least based on a third parameter set, and the third parameter set comprises one or more of the following parameters: an identifier of a terminal device; a sequence index to identify the third sequence; a sequence type parameter to indicate a type of the third sequence; a density of the reference signals; a size of bandwidth, wherein the bandwidth comprises the M frequency domain resource units; a position of the bandwidth; a communication environment parameter; time domain information to indicate one or more time domain resource units associated with the M frequency domain resource units; and spatial domain information to indicate P antenna ports supported for the reference signals transmission, P is a positive integer.

In this application, a third sequence could be generated based on the third parameter set, for example, the transmitting apparatus could determine a length of the third sequence or sequence values in the third sequence based on the third parameter set. In other words, the transmitting apparatus could generate the third sequence considering a variety of parameters, to determine the positions of frequency domain resource units of reference signals, and a way to flexibly determine resources is provided.

With reference to the first aspect or the second aspect, in some embodiments, the method further comprises: transmitting or receiving one or more the parameters in the third parameter set.

In this application, all or part of parameters in the third parameter set (some parameters in the first parameter set may not be transferred if e.g. the transmitting apparatus and the receiving apparatus both know they can not be transferred) can be transferred between a transmitting apparatus and a receiving apparatus, so that the transmitting apparatus and the receiving apparatus can determine a same relationship based on the second parameter set, and the transmission resource consumption used to indicate reference signal pattern can be reduced.

With reference to the first aspect or the second aspect, in some embodiments, the third sequence has a second relationship with the third parameter set, and the second relationship is determined at least based on a fourth parameter set, the fourth parameter set comprises one or more of the following parameters: an identifier of a terminal device; a second relationship type parameter to indicate a type of the second relationship; a second relationship index to identify the second relationship; a density of the reference signals; a size of bandwidth, wherein the bandwidth comprises the M frequency domain resource units; a position of the bandwidth; a communication environment parameter; time domain information to indicate one or more time domain resource units associated with the M frequency domain resource units; and spatial domain information to indicate P antenna ports supported for the reference signals transmission, P is a positive integer.

In this application, there is a second relationship between the third sequence and the third parameter set. For example, in some embodiments, the third sequence and the third parameter set could meet a second function, and the second function could be determined based on a fourth parameter set. For example, multiple functions could be used to generate a third sequence, and at least one second function could be selected from the multiple functions based on the fourth parameter set. Thus, more flexible way to determine reference signal patterns is provided.

With reference to the first aspect or the second aspect, in some embodiments, the method further comprises: transmitting or receiving one or more the parameters in the fourth parameter set.

In this application, all or part of parameters in the fourth parameter set (some parameters in the first parameter set may not be transferred if e.g. the transmitting apparatus and the receiving apparatus both know they can not be transferred) can be transferred between a transmitting apparatus and a receiving apparatus, so that the transmitting apparatus and the receiving apparatus can determine a same relationship based on the fourth parameter set, and the transmission resource consumption used to indicate reference signal pattern can be reduced.

With reference to the first aspect or the second aspect, in some embodiments, a length of the second sequence is greater than or equal to a threshold, and the threshold is determined at least based on the first parameter set.

For example, in some embodiments the threshold may be determined at least based on a communication environment parameter.

For example, in some embodiments the length of the second sequence may be determined at least based on a communication environment parameter.

In this application, the minimum value of the length of the second sequence can be defined, that is, the minimum value of the number of frequency domain resource units used to transmit reference signals can be defined. For example, the number of frequency domain resource units could be defined based on a communication environment parameter. For example, the minimum value in a complex communication environment (such as an urban area) could be greater than the minimum value in a simple communication environment (such as a rural area), and the number of frequency domain resource units could be determined within a reasonable range for each environment.

With reference to the first aspect or the second aspect, in some embodiments, the second sequence is a pseudo-random sequence.

In this application, sequence values in the second sequence have a random characteristic property, and the M positions of the M frequency domain resource units indicated by the sequence values are non-uniform in a frequency domain. In other words, multiple kinds of reference signal patterns can be supported, and multiple users can be assigned with different reference signal patterns, hence the probability of resource conflicts between multiple terminal devices is reduced.

With reference to the first aspect or the second aspect, in some embodiments, the K antenna ports are in P antenna ports supported for the reference signals transmission, where P is a positive integer, P>K.

In this application, some of the antenna ports could be associated with the M frequency domain resource units, that is, the transmitting apparatus could transmit reference signals using part of the antenna ports, which may reduce spatial domain resource consumption.

With reference to the first aspect or the second aspect, in some embodiments, the K antenna ports are indicated by a fourth sequence, length of the fourth sequence is M, and a frequency domain resource indicated by the i-th sequence value in the second sequence is related to an antenna port indicated by the i-th sequence value in the third sequence, i is a positive integer, i≤M.

In this application, the association between the M frequency domain resource units and the K antenna ports could be applied after the number of frequency domain resource units is determined. In other words, the number of antenna ports may not be considered when designing positions of frequency domain resource units, and the frequency domain resource consumption of reference signals could be controlled in a reasonable range even if the number of antenna ports is huge.

With reference to the first aspect or the second aspect, in some embodiments, K≥2.

In this application, the transmitting apparatus could generate one second sequence for all multiple K antenna, in contrast to predefining positions of frequency domain resource units for each antenna port. This method could keep the number of frequency domain resource units within a reasonable range, even in a communication system with multiple antenna ports.

With reference to the first aspect or the second aspect, in some embodiments, the second sequence is associated with the K antenna ports.

In this application, the transmitting apparatus could generate a second sequence for all the K antenna ports at once, that is, the transmitting apparatus could determine the positions of the M frequency domain resource units first, then associate the M frequency domain resource units with the K antenna ports. This method could keep the number of frequency domain resource units within a reasonable range, even in a communication system with multiple antenna ports.

According to a third aspect, a transmitting apparatus is provided. The transmitting apparatus includes a function or unit configured to perform the method according to the first aspect or any one of the possible embodiments of the first aspect.

For example, the transmitting apparatus could be a network device or a chip in the network device. For another example, the transmitting apparatus could be a terminal device or a chip in the terminal device.

According to a fourth aspect, a receiving apparatus is provided. The receiving apparatus includes a function or unit configured to perform the method according to the second aspect or any one of the possible embodiments of the second aspect.

For example, the receiving apparatus could be a terminal device or a chip in the terminal device. For another example, the receiving apparatus could be a network device or a chip in the network device.

According to a fifth aspect, a system is provided. The system includes: the transmitting apparatus according to the third aspect and the receiving apparatus according to the fourth aspect.

According to a sixth aspect, a communication apparatus is provided. The communication apparatus includes at least one processor, and the at least one processor is coupled to at least one memory. The at least one memory is configured to store a computer program or one or more instructions. The at least one processor is configured to: invoke the computer program or the one or more instructions from the at least one memory and run the computer program or the one or more instructions, so that the communication apparatus performs the method in any one of the first aspect or the possible implementations of the first aspect, or the communication apparatus performs the method in any one of the second aspect or the possible implementations of the second aspect.

With reference to the sixth aspect, in some implementations of the sixth aspect, the communication apparatus may be a transmitting apparatus. For example, the communication apparatus may be a network device or a component (for example, a chip or integrated circuit) installed in the network device. For another example, the communication apparatus may be a terminal device or a component (for example, a chip or integrated circuit) installed in the terminal device.

With reference to the sixth aspect, in some implementations of the sixth aspect, the communication apparatus may be a receiving apparatus. For example, the communication apparatus may be a terminal device or a component (for example, a chip or integrated circuit) installed in the terminal device. For another example, the communication apparatus may be a network device or a component (for example, a chip or integrated circuit) installed in the network device.

According to a seventh aspect, a communication apparatus is provided. The communication apparatus includes a processor and a communications interface. The processor is connected to the communications interface. The processor is configured to execute the one or more instructions, and the communications interface is configured to communicate with other network elements under the control of the processor. The processor is enabled to perform the method according to the first aspect or any one of the possible embodiments of the first aspect, or the second aspect or any one of the possible embodiments of the second aspect.

According to an eighth aspect, a computer storage medium is provided. The computer storage medium stores program code, and the program code is used to execute one or more instructions for the method according to the first aspect or any one of the possible embodiments of the first aspect, or the second aspect or any one of the possible embodiments of the second aspect.

According to a ninth aspect, this application provides a computer program product including one or more instructions, where when the computer program product runs on a computer, the computer performs the method according to the first aspect or any one of the possible embodiments of the first aspect, or the second aspect or any one of the possible embodiments of the second aspect.

### DESCRIPTION OF THE DRAWINGS

FIG. 1 is a schematic diagram of an application scenario according to this application;

FIG. 2 illustrates an example communication system 100;

FIG. 3 illustrates another example of an ED 110 and a base station 170a, 170b and/or 170c;

FIG. 4 is an example of a channel model of a MIMO system;

FIG. 5 is a schematic flowchart of a communication method 500 according to an embodiment of this application;

FIG. 6 is a schematic diagram of a second sequence indicating the positions of six frequency domain resource units;

FIG. 7 is a schematic diagram of a first function used to generate a second sequence;

FIG. 8 is a schematic diagram of the first example provided in this application;

FIG. 9 is a schematic diagram of the second example provided in this application;

FIG. 10 is a schematic diagram of the third example provided in this application;

FIGS. 11-15 are schematic block diagrams of possible devices according to embodiments of this application; and

FIGS. 16-31 are schematic block diagrams of possible examples according to embodiments of this application.

### DETAILED DESCRIPTION OF THE ILLUSTRATIVE EMBODIMENTS

The following describes technical solutions of the present application with reference to the accompanying drawings.

The technical solutions in embodiments of this application may be applied to various communications systems, such as a Global System for Mobile Communications (GSM), a Code Division Multiple Access (CDMA) system, a Wideband Code Division Multiple Access (WCDMA) system, a general packet radio service (GPRS) system, a Long Term Evolution (LTE) system, an LTE frequency division duplex (FDD) system, an LTE time division duplex (TDD) system, a Universal Mobile Telecommunications System (UMTS), a Worldwide Interoperability for Microwave Access (WiMAX) communications system, a wireless local area network (WLAN), a fifth generation (5G) wireless communications system, a new ratio (NR) wireless communications system, a sixth generation (6G) wireless communications system, or other evolving communications systems.

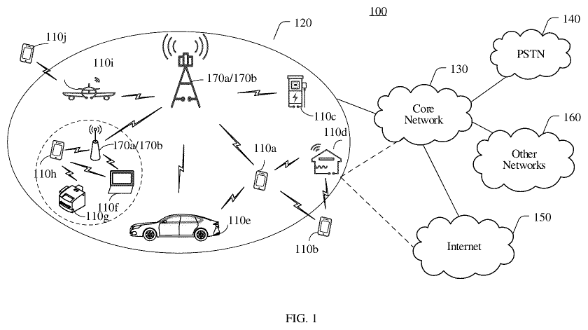

For ease of understanding the embodiments of this application, a communications system shown in FIGS. 1-3 is first used as an example to describe in detail a communications system to which the embodiments of this application are applicable.

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

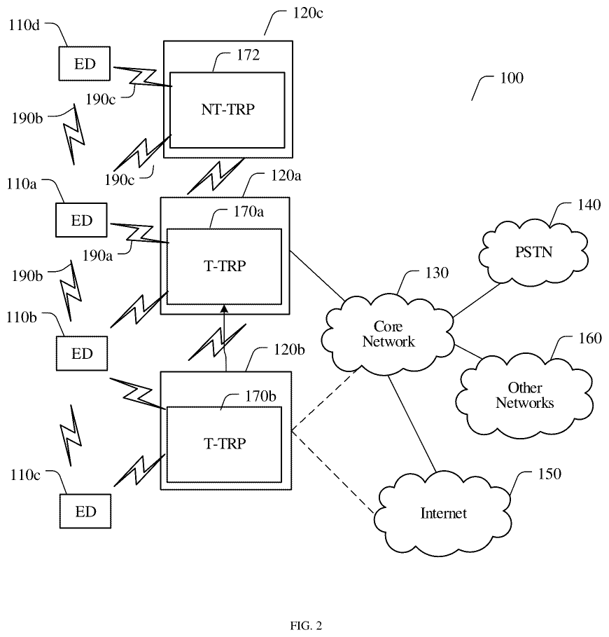

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

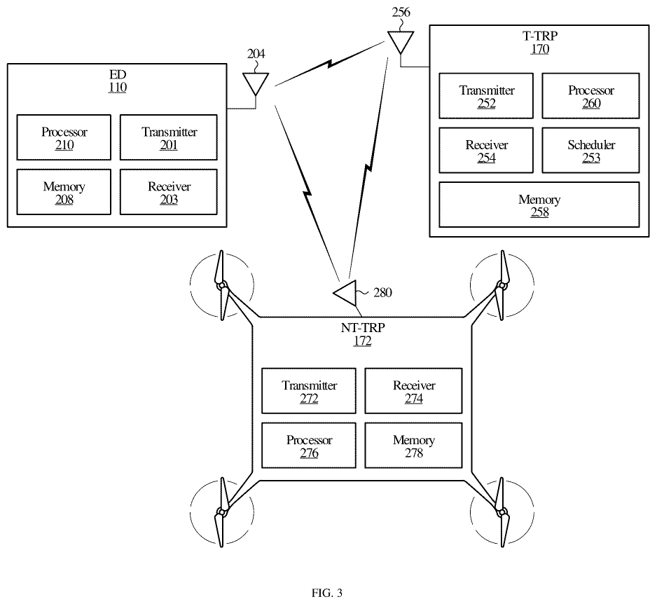

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some embodiments, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), radio unit (RU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

The CU (or CU-control plane (CP) and CU-user plane (UP)), DU or RU may be known by other names in some embodiments. For example, in open RAN (ORAN) system, the CU may also be referred to as open CU (O-CU), DU may also be referred to as open DU (O-DU), CU-CP may also be referred to open CU-CP (O-CU-CP), CU-UP may also be referred to as open CU-UP (O-CU-CP), and RU may also be referred to open RU (O-RU). Any one of the CU (or CU-CP, CU-UP), DU, or RU could be implemented through a software module, a hardware module, or a combination of software and hardware modules.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some embodiments, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

For ease of understanding the embodiments of this application, the following briefly describes a process of transmitting reference signals and measuring channels based on the reference signals.

Multiple input multiple-output (MIMO) technology allows an antenna array of multiple antennas to perform signal transmissions and receptions to meet high transmission rate requirements. The above ED 110 and T-TRP 170, and/or NT-TRP use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attentions from the academia and the industry. In the large-scale MIMO system, the T-TRP 170, and/or NT-TRP 172 is generally configured with more than ten antenna units (such as 128 or 256), and serves dozens of the ED 110 (such as 40). A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increased number of antennas allows each antenna unit to be smaller in size with a lower cost. Using the degree of spatial freedom provided by the large-scale antenna units, the T-TRP 170, and NT-TRP 172 of each cell can communicate with many ED 110 in the cell on the same time-frequency resource at the same time, thus greatly increasing the spectrum efficiency. A large number of antenna units of the T-TRP 170, and/or NT-TRP 172 also enable each user to have better spatial directivity for uplink and downlink transmission, so that the transmitting power of the T-TRP 170, and/or NT-TRP 172 and an ED 110 is reduced, and the power efficiency is increased. When the antenna number of the T-TRP 170, and/or NT-TRP 172 is sufficiently large, random channels between each ED 110 and the T-TRP 170, and/or NT-TRP 172 can approach orthogonal, and the interference between the cell and the users and the effect of noises can be eliminated. The plurality of advantages described above enable large-scale MIMO systems to have good prospects for application.

A MIMO system may include a receiver connected to a receive (Rx) antenna, a transmitter connected to transmit (Tx) antenna, and a signal processor connected to the transmitter and the receiver. Each of the Rx antenna and the Tx antenna may include a plurality of antennas. For instance, the Rx antenna may have an ULA antenna array in which the plurality of antennas are arranged in line at even intervals. When a radio frequency (RF) signal is transmitted through the Tx antenna, the Rx antenna may receive a signal reflected and returned from a forward target.

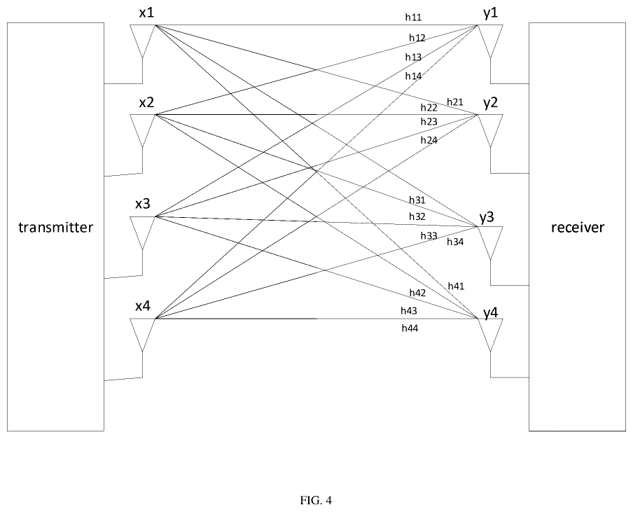

FIG. 4 is an example of a channel model of a MIMO system. A transmitter is connected to four TX antennas, x1 to x4, a receiver is connected to four RX antennas, y1 to y4, and a transmission channel may be formed between each TX antenna and each RX antenna. For example, an RF signal transmitted through x1 may be received by y2 through channel h21. The RF signal transmitted through x3 may be received by y1 through channel h13.

In a MIMO system, to implement functions such as system synchronization, channel information feedback, and data transmission, channel estimation needs to be performed on an uplink channel or a downlink channel. Channel estimation refers to the process of reconstructing or restoring received signals to compensate for signal distortion caused by channel fading and noise. In channel estimation, a reference signal predicted by a transmitter and a receiver may be used to track a change in the time domain and/or frequency domain of a channel, so as to reconstruct or restore a received signal. The reference signal may also be referred to as a pilot signal, a reference sequence or the like, and is described as a reference signal in the following for ease of understanding. The reference signal comprises, for example, a channel state information-reference signal (CSI-RS), a sounding reference signal (SRS), a demodulation reference signal (DMRS), phase track reference signals (PT-RS), or cell reference signals (CRS). The reference signals listed above are merely examples, and shall not constitute any limitation on this application. This application does not exclude the possibility that other reference signals are defined in a future protocol to implement the same or similar function.

To facilitate understanding of the embodiments of this application, the CSI-RS is described in detail by example below. The CSI-RS is mainly used for downlink channel estimation corresponding to a physical antenna port. For example, a receiving apparatus (i.e. a terminal device) may perform channel estimation on each physical antenna port based on a CSI-RS sent by a transmitting apparatus ((i.e. a network device), to feedback channel state information (CSI) based on a channel estimation result. The CSI may include related information such as a channel quality indicator (CQI), a precoding matrix indicator (PMI), a layer indicator (LI), and a rank indicator (RI). The CSI is used to reconstruct or precode the downlink channel. In some embodiments, a process in which the base station obtains CSI may include: the base station sends a reference signal to the UE; the UE obtains an estimated CSI value according to the received reference signal, selects a precoding vector from a codebook according to the estimated CSI value, and feedback related to the index of the precoding vector to the base station; and the base station determines a CSI reconstruction value with reference to the index of the precoding vector. The CSI reconstruction value can be a CSI closest to the true value of the CSI that can be obtained by the base station.

In an embodiment, a transmitting apparatus maps a sequence of reference signals to certain physical resources, and transmits the reference signals over the certain physical resources, where the sequence of reference signals and the physical resources are known to both the transmitting apparatus and the receiving apparatus receiving the reference signals. Thus, the receiving apparatus could perform channel estimation based on the known sequence of reference signals and the received signals.

A transmitting apparatus may map a sequence to physical resources to transmit reference signals. The physical resources may comprise multiple resource elements, where the resource elements are with the physical resources allocated for transmission of the reference signals, for example, the resource elements are with the common resource blocks allocated for physical downlink shared channel (PDSCH) transmission when DM-RSs are transmitted.

Positions of physical resources of reference signals may be referred to as reference signal patterns or pilot patterns. The positions of the physical resources are generally described through at least one of the following dimensions: time dimension, frequency dimension, or spatial dimension.

The time dimension could be represented by one or more time domain resource units. A time domain resource unit may include, but is not limited to, a symbol, an orthogonal frequency division multiplexing (OFDM) symbol, and a slot. In some embodiments, the time domain unit may be represented by a symbol index, an OFDM symbol index, or a slot index.

The frequency dimension could be represented by one or more frequency domain resource units. A frequency domain resource unit may include, but is not limited to, a subcarrier, or a subband. In some embodiments, the frequency domain unit may be represented by a subcarrier index, or a subband index. In some embodiments, the frequency domain unit may also be represented by a resource element (RE) index, a resource block (RB) index, or a resource block group (RBG) index. An RE consists of a symbol in a time domain and a subcarrier in a frequency domain, and an RE index could be used to indicate a position of a subcarrier. An RB consists of a slot in the time domain and 12 consecutive subcarriers in the frequency domain. An RB index could be used to indicate positions of 12 subcarriers. An RBG consists of a group of RBs, and an RBG index could be used to indicate positions of a group of subcarriers.

The spatial dimension could be represented by one or more spatial domain resource units. A spatial domain resource unit may be represented by an antenna port. In the embodiments of this application, an antenna port may be a Tx antenna. The antenna port may be identified by an antenna port index.

To facilitate understanding of the embodiments of this application, in the following exemplary description, a symbol index is used to represent a position of a time domain resource unit, a subcarrier index is used to represent a position of a frequency domain resource unit, and an antenna port index is used to represent a position of a spatial domain resource unit.

A process of channel estimation described above is merely an example for description, and shall not constitute any limitation on this application. Processes of channel estimation, are known in conventional technology and, for brevity, detailed descriptions of the specific processes are omitted herein.

The receiving apparatus could be an ED (i.e. a terminal device) and the transmitting apparatus could be a T-TRP or NT-TRP (i.e. a network device), or the receiving apparatus could be a T-TRP or NT-TRP (i.e. a network device) and the transmitting apparatus could be an ED (i.e. a terminal device). For example, the transmitting apparatus could be a network device and the receiving apparatus could be a terminal device when the reference signals are downlink signals (i.e. CSI-RS). The transmitting apparatus could be a terminal device and the receiving apparatus could be a network device when the reference signals are uplink signals (i.e. SRS). While one transmitting apparatus could transmit reference signals to multiple receiving apparatus, the following embodiments are illustrative of one transmitting apparatus and one receiving apparatus.

This application provides a communication method and apparatus. In this application, a second sequence could be generated based on a first parameter set and a third sequence, where the second sequence indicates M positions of M frequency domain resource units, and a first sequence of reference signals is mapped to the M frequency domain resource units, that is, in contrast to predefining positions of frequency domain resource units for the reference signals, the second sequence generated based on the first parameter set and the third sequence makes determining the positions of the frequency domain resource units more flexible. In the following, the communication method provided in this application will be described in combination with FIG. 5.

FIG. 5 is a schematic flowchart of a communication method 500 according to an embodiment of this application. The communication method 500 may be applied to the communications system described above.

At S510, a transmitter generates a first sequence of reference signals.

The manner of generating a first sequence is related to the type of reference signals. For example, the first sequence may be defined by a length-31 Gold sequence. This is not limited in this application.

The “first sequence” is only named for differentiation and does not limit the scope of protection of the embodiments of this application. Similarly, a “second sequence”, a “third sequence”, and a “first parameter set”, a “second parameter set”, etc. in the following description are also only named for differentiation and do not limit the scope of protection of the embodiments of this application, and this will not be repeated below.

At S520, the transmitter maps the first sequence of reference signals to M frequency domain resource units on K antenna ports, and M positions of the M frequency domain resource units are indicated by a second sequence.

The second sequence is generated based on a first parameter set, and M and K are positive integers, M≥K. The transmitting apparatus could determine M positions of the M frequency domain resource units by determining the second sequence, and associate the M frequency domain resource units to the K antenna ports. The second sequence is generated at least based on a first parameter set, that is, in contrast to predefining positions of frequency domain resource units for the reference signals. Generating the second sequence based on the first parameter set makes the process of determining the reference signal pattern more flexible.

A second sequence indicates M positions of the M frequency domain resources. In some implementations, a length of the second sequence is M, and M sequence values in the second sequence could be in one-to-one correspondence to the M frequency domain resources.

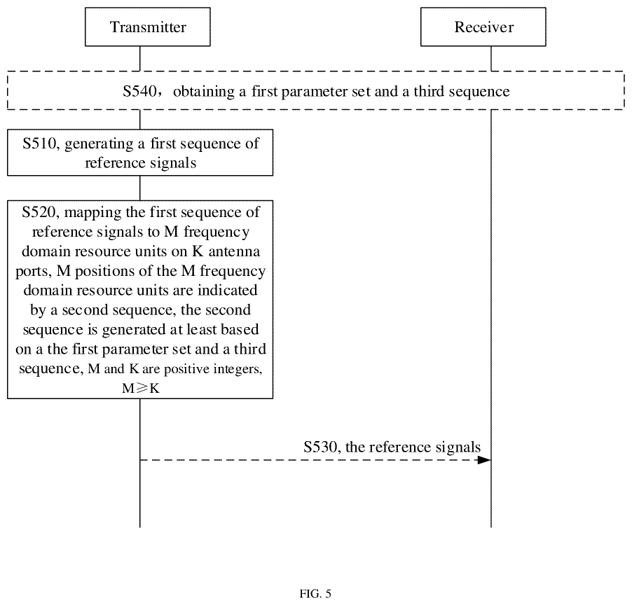

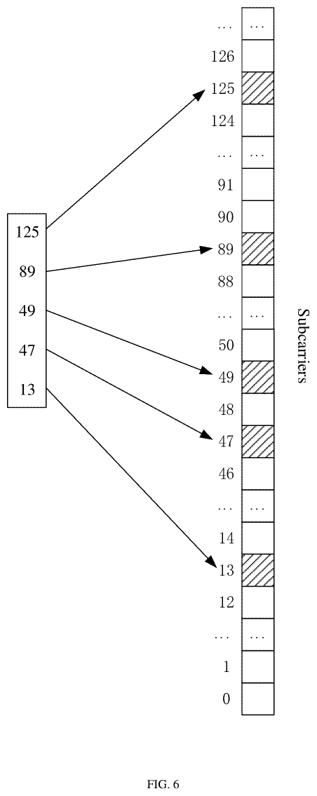

For example, FIG. 6 is a schematic diagram of a second sequence indicating the positions of six frequency domain resource units. As shown in FIG. 6, six sequence values form a second sequence {13, 47, 49, 89, 125}. The six sequence values are indexes of 6 subcarriers, which means that the first sequence of reference signals could be mapped to subcarrier index 13, index 47, index 49, index 89 and index 125.

An example of a second sequence consisting of indexes of subcarriers is proposed, and in some embodiments, some other form of information could have a similar meaning to the second sequence. For example, a string of binary numbers {001010001010}, where the position of binary number “1” could indicate the position of the frequency domain resource unit, such as subcarrier index 3, index 5, index 9 and index 11. For another example, a pattern may be used to represent the positions of the frequency domain resource units. That is, position of binary number of a predefined number in the second sequence could represent the position(s) of the frequency domain resource unit. The embodiments of the present application do not specifically limit this.

In some embodiments, the second sequence is a pseudo-random sequence. In other words, M sequence values in the second sequence have a random characteristic property, and M positions of the M frequency domain resource units indicated by the M sequence values could be non-uniform in a frequency domain. Different from a uniform reference signal pattern with same interval between two adjacent frequency domain resource units, M positions of the M frequency domain resource units could have at least two sets of different intervals between two adjacent frequency domain resource units. In this embodiment, the number of types of reference signal pattern is much greater than the number of types of reference signal patterns defined by the subcarrier interval. For example, if a reference signal pattern is defined by setting the subcarrier interval to 1, then there are only two pattern types, one for odd-indexed subcarriers and one for even-indexed subcarriers. However, the number of pattern types is much larger than 2 when a pseudo-random sequence is used to indicate the positions of the frequency domain resource units. Therefore, the probability of two terminal devices being assigned with frequency domain resource units in the same positions is greatly reduced, and the probability of resource conflicts between multiple terminal devices is reduced.

The first parameter set could be used to generate the second sequence. The first parameter set includes one or more of the following: an identifier of a terminal device, a density of the reference signals, a size of bandwidth, a position of the bandwidth, a communication environment parameter, time domain information, and spatial domain information, where the bandwidth includes the M frequency domain resource units, the time domain information indicates one or more time domain resource units associated with the M frequency domain resource units, and the spatial domain information indicates P antenna ports supported for transmission of the reference signals, where P is a positive integer.

In the description of this application, “generating A based on B” and “generating A at least based on B” can have the same meaning. The phrases “determining A based on B” and “determining A at least based on B” also can have a same meaning. This will not be repeated below.

Possible parameters in the first parameter set and their application in the embodiments will be described in detail below.

An identifier of a terminal device may be of various types. For example, the identifier of the terminal device includes one or more of the following: a UE identifier (UE ID), a cell radio network temporary identifier (C-RNTI), a physical cell identifier (PCI), a random access radio network temporary identifier (RA-RNTI), a temporary C-RNTI, and a transmit power control radio network temporary identifier (TPC-RNTI). Thus, the transmitting apparatus may generate different second sequences based on different identifiers of terminal devices, which means that different UEs could be allocated to different frequency domain resource units for reference signals. It should be noted that, the identifier described above may be a complete identifier or a part of the identifier. For example, a part of the UE-ID may be used to generate the second sequence for a particular UE. In some scenarios, this is enough to generate different second sequence for different UEs. This is not limited in this embodiment of this application.

The bandwidth in this application could refer to the bandwidth allocated to a terminal. For example, the bandwidth is frequency domain resource units allocated by a network device to a terminal for signal communications. The M frequency domain resource units are part or all of the frequency domain resource units in the bandwidth.

A size of the bandwidth could be used to determine the total number of frequency domain resource units allocated in the bandwidth. For example, if the size of the bandwidth is 200 Mega Hertz (MHz), the transmitting apparatus could determine the number of subcarriers in the bandwidth based on this size. The value of M may be less than or equal to the number of frequency domain resource units in the bandwidth.

A position of the bandwidth could be used to determine positions of the M frequency domain resource units used for reference signals. Sequence values in the second sequence could be determined based on the positions of the bandwidth. For example, if the second sequence consists of one or more indexes of subcarriers, then the sequence values in the second sequence may be all or part of subcarriers indexes in the bandwidth.

A density of reference signals could be used to determine the number of frequency domain resource units used for reference signals in a certain physical resource. For example, the density of reference signals can represent the number of subcarriers used for reference signals in a single symbol, such as six subcarriers associated with the single symbol for reference signals. For another example, if the density of reference signals represents 5% of the subcarriers in the bandwidth are used for reference signals, then the transmitting apparatus may determine the length of the second sequence (that is, M) to be 12 when bandwidth allocated to a terminal device includes 240 subcarriers.

A communication environment parameter may indicate the complexity or complication of the communication environment and may imply the number of frequency domain resource units to be used for reference signals. In some embodiments, the length of the second sequence is greater than a threshold, and the threshold is determined based on the communication environment parameter.

For example, the communication environment parameter may indicate the type of communication environment, such as an urban area or a rural area. Different types of communication environments could correspond to different thresholds. In some embodiments, the threshold corresponding to an urban area could be greater than the threshold corresponding to a rural area because the communication environment of the urban area may be more complex.

For another example, the communication environment parameter may indicate a channel rank, which may be used to determine a threshold. In some embodiments, the threshold may be greater than or equal to the ratio of the channel rank to the number of receiving antenna ports. For example, the threshold may be equal to the ratio or several times the ratio. The channel rank may be determined based on the complexity of the communication environment, such as the number of reflecting surfaces in the communication environment. The channel rank could be obtained by constructing a channel space basis matrix or similar channel-status-related matrix of the communication environment. For example, a network device may construct a channel space basis matrix for a communication area, where a rank of the channel space basis matrix could be used as a channel rank or could be used to deduce a channel rank. The rank could represent the smallest number of frequency domain resource units needed to measure a projection of target channel response on channel space basis matrix so as to reconstruct a target channel response for the communication area. In some embodiments, the reference signal sent by the transmitting apparatus through one antenna port could be received by the receiving apparatus using multiple receiving antenna ports. In this case, the channel estimation result could be obtained when the length of the second sequence (that is, M) is greater than or equal to the ratio of the channel rank to the number of receiving antenna ports. Therefore, a channel rank could be used to determine the minimum value of M.

Time domain information indicates one or more time domain resource units associated with M frequency domain resource units. For example, the time domain information may include a time domain resource unit index or identification, such as a symbol index, and a slot index. Therefore, a transmitting apparatus could determine which time domain resource unit is associated with the M frequency domain resource units. This application does not limit the number of time domain resource units that are associated with the M frequency domain resource units. In some embodiments, when multiple symbols are allocated, the time domain information could be used to determine how the second sequence could be generated, for example, the transmitting apparatus could generate a sequence for each symbol, and the generated sequences could constitute the second sequence.

Spatial domain information indicates a plurality of antenna ports supported for transmission of the reference signals. For example, the spatial domain information may include indexes of the plurality of antenna ports. K antenna ports (which are associated with M frequency domain resource units) may be part or all of the plurality of antenna ports supported for transmission of the reference signal. In some embodiments, the transmitting apparatus could generate a second sequence for all the K antenna ports at once, that is, the transmitting apparatus could determine the positions of the M frequency domain resource units first, then associate the M frequency domain resource units with the K antenna ports. This method could keep the number of frequency domain resource units within a reasonable range, even in a communication system with multiple antenna ports. In some embodiments, the transmitting apparatus could generate a sequence for each antenna port, where the generated sequences constitute a second sequence in this application.

In some embodiments, some of the above parameters could have an association relationship, that is, the transmitting apparatus could determine a parameter based on another parameter. For example, the transmitting apparatus could determine density of the reference signals based on a communication environment parameter. This is not limited in this application.

Based on the first parameter set described above, a third sequence provided by the embodiments of this application will be described below.

In some embodiments, sequence values in the third sequence may be generated from a value range. The value range may represent a range of a continuous set of real numbers. For example, sequence values in a third sequence {17, 48, 98, 110, 120} are selected from a value range of 1 to 120. For another example, sequence values in a third sequence {0.21, 0.34, 0.37, 0.53, 0.79, 0.91} are selected from a value range of 0 to 1.

Sequence values in the third sequence could be selected from the value range in a variety of ways. In some implementations, sequence values could be generated by a random generator. In some implementations, sequence values could be generated based on uniform distribution. Here are some examples of the third sequence generated based on uniform distribution. A third sequence {1, 30, 59, 88, 117} is generated based on uniform integer interval 29, a third sequence {0.17, 0.33, 0.50, 0.67, 0.83, 1} is generated based on uniform decimal interval 0.17. This is not limited to this application, for example the third sequence could also be generated by an optimal search algorithm (such as a QR decomposition method), an artificial intelligence (AI) algorithm or other possible ways. In some embodiments, the third sequence is determined at least based on a third parameter set, which could be found in the following paragraphs.

How to generate a second sequence based on the first parameter set and the third sequence is introduced in detail in the following paragraphs.

The length of the second sequence could be determined based on the third sequence or the first parameter set. In some embodiments, the length of the second sequence is equal to the length of the third sequence. In some embodiments, the length of the second sequence is determined based on a communication environment parameter.

Sequence values in the second sequence could be determined based on the third sequence and the first parameter set. For example, the second sequence has a first relationship with the first parameter set and the third sequence, and the sequence values in the second sequence is generated according to the first relationship since the first parameter set and the third sequence are known to the transmitter.

In some embodiments, a ratio of the j-th sequence value in the third sequence to the size of value range is related to a ratio of the j-th sequence value in the second sequence to the number of the frequency domain resource units in the bandwidth. The value range represents a range of continuous real number and the size of value range could be equal to the difference between the maximum value and the minimum value of the continuous real number. For ease of description, the size of value range could be represented as S1, and the number of frequency domain resource units in the bandwidth could be represented as S2, which could be determined based on the size of the bandwidth. Ratios of sequence values in the third sequence to S1 could reflect a value distribution characteristic. Ratios of sequence values in the second sequence to S2 could reflect a distribution characteristic of the M positions of the M frequency domain resource units when the second sequence consists of indexes of the M frequency domain resource units. For example, the ratios of sequence values in the third sequence to S1 are related to the ratios of sequence values in the second sequence to S2, that is, the distribution characteristic of the M positions of the M frequency domain resource units could be determined based on the third sequence.

To facilitate the understanding of the embodiments of this application, the first relationship may be represented as a first function, where the first parameter set and the third sequence are the input to the first function (such as the first parameter set could be used to determine one or more coefficients of the first function), and the second sequence is the output of the first function. In the description below, the first relationship will be illustrated in relation to the first function.

For example, FIG. 7 is a schematic diagram of a first function used to generate a second sequence. Two or more devices (such as a transmitting apparatus and a receiving apparatus) could obtain a same second sequence based on the first function, the third sequence and the first parameter set. Therefore, the second sequence (which may cause signaling overhead) may not be transmitted directly between the transmitting apparatus and the receiving apparatus.

To facilitate the understanding of the implementations of this application, a possible form of the first function generating a second sequence will be illustrated exemplarily below.

$${s}_{i} = ⌊ {x}_{i} * a ⌋ + b , i = 1 , … , outputLength 1 \qquad ( 1 )$$

An output of this first function, that is, sᵢ, may be represented as {s₁, s₂, . . . , s_{outputLength1}}, which is the second sequence provided in this application. xᵢ may be represented as {x₁, x₂, . . . , x_{outputLength1}}, which is the third sequence provided in this application. The coefficients of the first function could be represented as {a, b, outputLength1}. All or part of the coefficients may be determined based on the first parameter set described above. In some implementations, the coefficient “a” may represent a scaling factor and may be determined based on the size of the bandwidth and the value range of the third sequence. For example, the value of coefficient “a” could be equal to the ratio of S2 to S1. In some implementations, the coefficient “b” may represent an offset factor and may be determined based on the position of the bandwidth. For example, an index of the starting subcarrier of the bandwidth could be determined based on the position of the bandwidth, and the value of coefficient “b” could be equal to the index of the starting subcarrier of the bandwidth. In some embodiments, the coefficient “outputLength1” could be equal to the length of the third sequence.

For example, the transmitting apparatus obtains a third sequence {0.05, 0.44, 0.53, 0.84}, which is generated from a value range of 0 to 1 (S1=1). Therefore, the length of the third sequence is 4. A size of the bandwidth is used to determine that the number of the subcarriers in the bandwidth is equal to 24 (S2=24). A position of the bandwidth is used to determine that the index of starting subcarrier in the bandwidth is equal to 48. Thereby, the values of coefficients of the first function may be represented as {a=24, b=47, outputLength1=4}, and the second sequence {48, 57, 59, 67} is obtained by bringing these parameters into (1). It is generated based on the first parameter set and the third sequence, which may indicate the positions of the frequency domain resource units the first sequence to be mapped, that is, subcarrier index 48, index 57, index 59 and index 67.

One or more parameters in the first parameter set could be used to determine the one or more coefficients of the function, for example, the coefficient “a”, and “b” in the first function (1). Alternatively, one or more parameters in the first parameter set could be used to determine the length of the second sequence directly, for example, the length of the second sequence (which is equal to the “outputLength1”) is determined based on one or more parameters in the first parameter set. In some embodiments, the transmitting apparatus and the receiving apparatus could pre-determine the coefficient “a”, and “b”, and one apparatus could transmit the “outputLength1” to another apparatus. This is not limited in this application.

The above first function is an example to facilitate understanding of the implementations of this application, different apparatus could generate the same second sequence based on the same first sequence, third sequence and first function.

In some embodiments, the transmitting apparatus could obtain more than one first functions (the first relationship between a first parameter set and a third sequence and a second sequence), and the transmitting apparatus could select one or more first functions among the multiple first functions to generate the second sequence. In some embodiments, the multiple first functions are stored in the transmitting apparatus or a memory coupled to the transmitting apparatus. In some embodiments, the transmitting apparatus could obtain the multiple first functions from the receiving apparatus. This is not limited in this application.

The transmitting apparatus may generate a second sequence based on more than one first functions to generate multiple sequences for multiple antenna ports or multiple time domain resource units, where the multiple sequences constitute the second sequence. For brevity, the following is presented by selecting one first function as an example.

For example, the first function (relationship) is determined based on a second parameter set, and the second parameter includes one or more of the following: an identifier of a terminal device, a density of the reference signals, a size of bandwidth, a position of the bandwidth, time domain information, spatial domain information, a first relationship index, a first relationship type parameter, and a communication environment parameter.

Description about an identifier of a terminal device, a density of the reference signals, bandwidth (the size and the position), time domain information, spatial domain information, and a communication environment parameter could be as described in the description above, and will not be repeated. The transmitting apparatus could select a first function based on the second parameter set, for example, the transmitter could select different first functions based on different identifiers.

A first relationship type parameter could be used to indicate the type of the first relationship. A type of a first function (relationship) could be defined based on the property of the first function. For example, if a second sequence output by the first function is a pseudo-random sequence, the type of the first function may be referred to as a random type or a non-uniform type. If a second sequence output by the first function is a uniform sequence, the type of the first function may be referred to as a uniform type. This is not limited in this application. In some embodiments, different types of first functions could correspond to different communication environments. For example, urban areas could correspond to a random type of first function and rural areas could correspond to a uniform type of first function.

The first relationship index could be used to identify the first relationship. In some embodiments, the transmitting apparatus could obtain the index of the first function. For example, if the transmitting apparatus is a terminal device, it can receive the index of the first function from a network device or other devices.

The above description of determining the first function based on the second parameter set is only for illustrative purpose. This is not limited in this application, for example, the transmitting apparatus could determine a group of functions based on the type parameter, and select one function from the group of functions based on a communication environment parameter.

A transmitting apparatus and a receiving apparatus could maintain a table with multiple first functions, and the form of the table may be related to the way a first function is determined (i.e. the second parameter set being used to determine the first function). To facilitate the understanding of this application embodiment, a possible table with multiple first functions is given in the following Table 1.

TABLE 1

| | Type of | | Indexes | |
|---|---|---|---|---|
| Row | first | Type of | of first | |
| index | functions | environment | functions | First functions |
| 1 | Random | Urban 1 | 1 | First function#1 |
| 2 | | | 2 | First function#2 |
| 3 | | | 3 | First function#3 |
| . | | | . | . |
| . | | | . | . |
| . | | | . | . |
| n | | | n | First function#n |
| n + 1 | | Urban 2 | 1 | First function#n + 1 |
| n + 2 | | Rural 1 | 1 | First function#n + 2 |
| n + 3 | Uniform | Urban 1 | 1 | First function#n + 3 |
| n + 4 | | Rural 1 | 1 | First function#n + 4 |

In exemplary Table 1, n is an integer greater than 1, multiple functions are grouped based on the type of environment and the type of functions. The transmitting apparatus could select a function based on a second parameter (the type of environment and the type of functions in Table 1), and generate a second sequence based on the selected function and a first parameter set.

How to generate a second sequence based on the first parameter set and the third sequence described above, how to generate a third sequence based on a third parameter set provided by the embodiments of this application will be described below.

In a first embodiment (way 1 in FIG. 7), the transmitting apparatus could obtain multiple sequences, and could select one or more sequences among the multiple sequences based on the third parameter set, where the selected sequences constitute the third sequence. The third parameter set includes one or more of the following: an identifier of a terminal device, a density of the reference signals, a size of bandwidth, a position of the bandwidth, time domain information, spatial domain information, a sequence index, a sequence type parameter, and a communication environment parameter.

Description about an identifier of a terminal device, a density of the reference signals, bandwidth (the size and the position), time domain information, spatial domain information, and a communication environment parameter could be as described in the description above, and will not be repeated. The transmitting apparatus could select a sequence based on the third parameter set, for example, the transmitting apparatus could select different sequences based on different identifiers.

A sequence type parameter could be used to indicate the type of the third sequence. A type of a third sequence could be defined based on the property of the third sequence. For example, if a third sequence is a pseudo-random sequence, the type of the third sequence may be referred to as a random type or a non-uniform type. If a third sequence is a uniform sequence, the type of the third sequence may be referred to as a uniform type. This is not limited in this application. In some implementations, different types of third sequences could correspond to different communication environments, for example, urban areas could correspond to a random type of third sequence and rural areas could correspond to a uniform type of third sequence.

The sequence index could identify the third sequence. In some embodiments, the transmitting device could obtain the index of the third sequence. For example, if the transmitting apparatus is a terminal device, it can receive the index of the third sequence from a network device or other devices.

The above description of determining the third sequence based on the third parameter set is only for illustrative purpose. This is not limited in this application, for example, the transmitting apparatus could determine a group of basis sequences based on the sequence type parameter, and select one basis sequence from the group of basis sequences based on a communication environment parameter.

For ease of description, the multiple sequences could be referred to as basis sequences in this application. These multiple basis sequences could be in a form of one table or a series of tables, and each table has several rows and each row gives a basis sequence. For ease to understand the embodiments of this application, examples of multiple basis sequences are presented in the following Table 2.

TABLE 2

| | | | | indexes | |
|---|---|---|---|---|---|
| Row | Type of | Value | | of basis | |
| index | environment | Range | Length | sequences | Basis sequences |
| 1 | Urban 1 | [0, | 8 | 1 | 47, 58, 68, 158, |
| | | 239] | | | 168, 176, 199, |
| | | | | | 239 |
| 2 | Urban 2 | [240, | 8 | 2 | 257, 272, 296, |
| | | 455] | | | 310, 339, 387, |
| | | | | | 426, 433 |
| . | . | . | . | . | . |
| . | . | . | . | . | . |
| . | . | . | . | . | . |
| n | Urban n | [0, 1] | 10 | n | 0.02, 0.05, 0.08, |
| | | | | | 0.44, 0.45, 0.46, |
| | | | | | 0.51, 0.53, 0.66, |
| | | | | | 0.70, 0.77, 0.84 |
| n + 1 | Rural 1 | [960, | 12 | 1 | 1011, 1033, 1049, |
| | | 1389] | | | 1057, 1093, 1152, |
| | | | | | 1247, 1313, 1325, |
| | | | | | 1370 |
| . | . | . | . | . | |
| . | . | . | . | . | |
| . | . | . | . | . | |
| n + m | Rural m | [0, 1] | 30 | m | 0.051, 0.116, |
| | | | | | 0.161, 0.143, |
| | | | | | 0.218, 0.272, |
| | | | | | 0.306, 0.309, |
| | | | | | 0.316, 0.321, |
| | | | | | 0.359, 0.415, |
| | | | | | 0.435, 0.440, |
| | | | | | 0.442, 0.498, |
| | | | | | 0.595, 0.631, |
| | | | | | 0.672, 0.680, |
| | | | | | 0.685, 0.720, |
| | | | | | 0.721, 0.728, |
| | | | | | 0.773, 0.817, |
| | | | | | 0.868, 0.904, |
| | | | | | 0.908, 0.937 |
| . | . | . | | . | . |
| . | . | . | | . | . |
| . | . | . | | . | . |

In exemplary Table 2, n and m are integers greater than 1, multiple basis sequences are grouped based on the type of environment, such as basis sequences with indexes 1-n for the urban area and the basis sequences with indexes 1-m for the rural area. The transmitter could select a third sequence based on the third parameter set (such as the type of environment in Table 2), and determine the M positions of the frequency domain resource units.

In a second implementation (way 2 in FIG. 7), the third sequence may have a second relationship with the third parameter set, and the third sequence is generated according to the second relationship since the third parameter set is known to the transmitter. The second relationship may be presented as a second function, where a third parameter set is the input to the second function (such as the third parameter could be used to determine one or more coefficients of the second function), and the third sequence is the output of the second function. To facilitate the understanding of the embodiments of this application, in the description below, the second relationship will be illustrated in relation to the second function.

The second function could include various operations to generate the third sequence. For example, the third sequence could be selected from a value range by the second function. For example, the second function may include at least one or more of the following operations: concurring, concatenating, random number generating, and uniform distributing. The present application does not limit this. Two or more devices (such as a transmitting apparatus and a receiving apparatus) could obtain a same third sequence based on the second function and the third parameter set. Therefore, the third sequence (which may cause signaling overhead) may not be transmitted directly between the transmitter and the receiver.

To facilitate the understanding of the embodiments of this application, a possible form of the second function generating a third sequence will be illustrated exemplarily below.

$${x}_{i} = \{ \begin{matrix}{seed}_{1} , & i = 1 \\ ( ( c * {x}_{i - 1} + d ) mod {m}_{1} ) / {m}_{2} , & i = 2 , … , outputLength 2\end{matrix} \qquad ( 2 )$$

An output of this second function, that is, xᵢ, may be represented as {x₁, x₂, . . . , x_{outputLength2}}, which is the third sequence provided in this application. The coefficients of the second function could be represented as {seed₁, c, d, m₁, m₂, outputLength2}. All or part of the coefficients may be determined based on the third parameter set described above. For example, the coefficient “m₂” may be determined based on the precision of the value range (that is, the number of digits taken after the decimal point). The transmitter could control the range of sequence values in the third sequence by controlling the value of the coefficient “m,” and coefficient “m₂”. In some embodiments, the coefficient “outputLength2” may be determined based on a communication environment parameter, and the value of the coefficient “outputLength2” determines the number of frequency domain resource units when the length of the second sequence is equal to the length of the third sequence. For example, the coefficient “seed,”, “c” or “d” may be determined based on an identifier of a terminal device, and different third sequences could be generated for different terminal devices.

The association relationship between coefficients and the third parameter set described above is only illustrative. The association relationship could be related to a form of a function, application scenario, and so on. This is not limited in this application.

In some embodiments, the transmitting apparatus could obtain more than one second functions (second relationship between a third parameter set and a third sequence), and the transmitter could select one or more second functions among the multiple second functions to generate the third sequence.

For example, the second function (relationship) is determined based on a fourth parameter set, and the fourth parameter set includes one or more of the following: an identifier of a terminal device, a density of the reference signals, a size of bandwidth, a position of the bandwidth, time domain information, spatial domain information, a second relationship index, a second relationship type parameter, and a communication environment parameter.

Description about the one or more parameters in the fourth parameter set could be referred to in the description above, and will not be repeated. The transmitting apparatus could select a second function based on the fourth parameter set, for example, the transmitting apparatus could select different second functions based on different identifiers.

A transmitting apparatus and a receiving apparatus could maintain a table with multiple second functions, and the form of the table may be related to the way a second function is determined (i.e. the fourth parameter set being used to determine the second function). To facilitate the understanding of this application, a possible table with multiple second functions is given in the following Table 3.

TABLE 3

| | Type of | | Indexes | |
|---|---|---|---|---|
| Row | second | Type of | of second | |
| index | functions | environment | functions | Second functions |
| 1 | Random | Urban 1 | 1 | Second function#1 |
| 2 | | | 2 | Second function#2 |
| 3 | | | 3 | Second function#3 |
| . | | | . | . |
| . | | | . | . |
| . | | | . | . |
| n | | | n | Second function#n |
| n + 1 | | Urban 2 | 1 | Second function#n + 1 |
| n + 2 | | Rural 1 | 1 | Second function#n + 2 |
| n + 3 | Uniform | Urban 1 | 1 | Second function#n + 3 |
| n + 4 | | Rural 1 | 1 | Second function#n + 4 |

In exemplary Table 3, n is an integer greater than 1, multiple second functions are grouped based on the type of environment and the type of second functions. The transmitting apparatus could select a second function based on a fourth parameter set (the type of environment and the type of second functions in Table 3), and generate a third sequence based on the selected second function and a fourth parameter set.

A second sequence indicating M positions of frequency domain resource units has been described above, and an association relationship between M frequency domain resource units and K antenna ports will be described below.

The total number of antenna ports supported for transmission of the reference signals could be P, where P is a positive integer, P≥K. In other words, the transmitting apparatus could select all or part of P antenna ports to transmit the reference signals. In some embodiments, the transmitting apparatus could determine whether to select part of P antenna ports at least based on the value of M, for example, the transmitting apparatus may determine that part of P antenna ports is selected when P is greater than M.

Antenna ports could be determined in a variety of ways. For example, K antenna ports with the smallest indexes among P antenna ports could be allocated to transmit reference signals. For another example, P antenna ports could be arranged based on values of antenna port indexes, and every p antenna ports could be selected to transmit reference signals, for example, every three antenna ports could be selected from 8 antenna port indexes 1-8, that is, the selected K antenna ports are antenna port indexes 1, 4, and 7. This is not limited in this application.

The association relationship between M frequency domain resource units and K antenna ports could be determined in a variety of ways. In some embodiments, the K antenna ports are indicated by a third sequence, a length of the third sequence is M, a frequency domain resource unit indicated by the i-th sequence value in the second sequence is related to an antenna port indicated by the i-th sequence value in the third sequence, and i is a positive integer, i≤M. For example, a second sequence {13, 47, 49, 89, 125, 137} could be generated to indicate subcarrier index 13, index 47, index 49, index 89, index 125, and index 137. Antenna port index 1, index 4, and index 7 could be selected, and the third sequence may be {1, 4, 7, 1, 4, 7}, which means that a sequence of reference signals are mapped to subcarrier index 13 on antenna port index 1, subcarrier index 47 on antenna port index 4, subcarrier index 49 on antenna port 7, subcarrier index 89 on antenna port 1, subcarrier index 125 on antenna port 4, and subcarrier index 137 on antenna port 7. Alternatively, the third sequence may be {1, 1, 4, 4, 7, 7}, which means that a sequence of reference signals is mapped to subcarrier index 13 on antenna port index 1, subcarrier index 47 on antenna port index 1, subcarrier index 49 on antenna port 4, subcarrier index 89 on antenna port 4, subcarrier index 125 on antenna port 7, and subcarrier index 137 on antenna port 7.

For ease of description, a second sequence (which indicates M frequency domain resource units) and a fourth sequence (which indicates K antenna ports) could be in the form of a sequence in a frequency-spatial domain, such as {13-1, 47-4, 49-7, 89-1, 125-4, 137-7}.

It should be noted that the way to generate a fourth sequence is not limited in this application. For example, the fourth sequence could be determined at least based on a fifth parameter set, where the fifth parameter set includes one or more of the following: an identifier of a terminal device, a density of the reference signals, a size of bandwidth, a position of the bandwidth, time domain information, spatial domain information, index of the relationship, a type of the relationship, and a communication environment parameter. Description about the above parameters could be referred to in the description above, and will not be repeated.

For example, the fourth sequence may have a third relationship with a fifth parameter set, and the third relationship between the fourth sequence and the fifth parameter set could represent as a third function. To facilitate the understanding of the embodiments of this application, a possible form of the third function generating a fourth sequence will be illustrated exemplarily below:

$${p}_{i} = \{ \begin{matrix}initalportindex , & i = 1 \\ ( {p}_{i - 1} + offset ) mod P , & i = 2 , … , outputLength 3\end{matrix} \qquad ( 3 )$$

An output of this third function, that is, Pᵢ, may be represented as {P₁, P₂, . . . , P_{outputLength3}}, which is the fourth sequence provided in this application. The coefficients of the third function could be represented as {initalportindex, offset, P, outputLength3}. All or part of the coefficients may be determined based on the fifth parameter described above. For example, the coefficient “P” could be the number of antenna ports supported for transmission of reference signals. The coefficient “outputLength3” may be determined based on a communication environment parameter, which may indicate the number of frequency domain resource units (which are associated with K antenna ports). This is not limited in this application.

A transmitting apparatus and a receiving apparatus could maintain a table with multiple third functions. In some embodiments, a first function (which is used to generate a second sequence in a frequency domain) and a third function (which is used to generate a fourth sequence in a spatial domain) may be associated in one table. To facilitate the understanding of this application, a possible table is given in the following Table 4.

TABLE 4

| | Type of | | Indexes | |
|---|---|---|---|---|
| Row | first | Type of | of first | |
| index | functions | environment | functions | Functions |
| 1 | Random | Urban 1 | 1 | First function#1; |
| | | | | Third function#1 |
| 2 | | | 2 | First function#2; |
| | | | | Third function#2 |
| 3 | | | 3 | First function#3 |
| | | | | Third function#3 |
| . | | | . | . |
| . | | | . | . |
| . | | | . | . |
| n | | | n | First function#n; |
| | | | | Third function#n |
| n + 1 | | Urban 2 | 1 | First function#n + 1 |
| | | | | Third function#n + 2 |
| n + 2 | | Rural 1 | 1 | First function#n + 3; |
| | | | | Third function#n + 3 |
| n + 3 | uniform | Urban 1 | 1 | First function#n + 4; |
| | | | | Third function#n + 4 |
| n + 4 | | Rural 1 | 1 | First function#n + 5; |
| | | | | Third function#n + 5 |

In exemplary Table 4, multiple functions are grouped based on the type of environment and the type of functions. The transmitting apparatus could generate a second sequence and a third sequence based on Table 4.

In some embodiments, the association relationship between M frequency domain resource units and K antenna ports could be determined based on the third sequence (which is used to generate a second sequence). The property that sequence values are arranged in a certain order is utilized, a certain antenna port may be associated with some sequence values at certain positions. For example, the first Q sequence values in the third sequence constitute one subsequences #1 which is associated with the antenna port with the smallest index, the next Q sequence values in the third sequence constitute the next subsequence #1 which is associated with the antenna port with the second smallest index, and so on, where the Q may be equal to the ratio of M to K (Q=M/K). In some embodiments, the third sequence includes K subsequences #1, and the K subsequences of the third sequence are associated with the K antenna ports. The M frequency domain resource units are divided into K frequency domain resource groups, and the K antenna ports are respectively associated with the K frequency domain resource groups.

For example, a third sequence {0.05, 0.44, 0.53, 0.84} includes two subsequences #1: {0.05, 0.44} and {0.53, 0.84}, where one subsequences #1 {0.05, 0.44} consisting of the first two sequence values in the third sequence is associated with antenna port 4, another subsequences #1 {0.53, 0.84} consisting of the next two sequences values in the third sequence is associated with antenna port 7. A second sequence {48, 57, 59, 67} is generated based on the third sequence, indicating 4 subcarriers, that is, subcarrier index 48, index 57, index 59, and index 67. The four subcarriers are divided into 2 frequency domain resource groups based on the way in which the third sequence is divided, that is, subcarrier index 48 and index 57 (which are indicated by the first two sequence values in the second sequence) constitute the first frequency domain resource group, which is associated with antenna port 4. Subcarrier index 59 and index 67 (which are indicated by the next two sequence values in the second sequence) constitute the second frequency domain resource group, which is associated with antenna port 7. In this embodiment, the positions of sequence values in the third sequence could be used to determine the association relationship between the M frequency domain resource units and the K antenna ports, and the complexity of designing of reference signal pattern is reduced.

The way in which the third sequence is divided into multiple subsequences could be predefined or determined based on one or more parameters, such as the value of K and the value of M. This is not limited to this application.

The association relationship between M frequency domain resource units and K antenna ports is described above, and an association relationship between the M frequency domain resource units and one or more time domain resource units will be described below.

In some embodiments, the M frequency domain resource units are associated with a single time domain resource unit, such as a single symbol. Therefore, the transmitting apparatus could determine that the first sequence of the reference signals is mapped to a physical resource defined by the time domain resource unit and the M frequency domain resource units, that is, the first sequence could be mapped to the M frequency domain resource units in the time domain resource unit. For example, the transmitting apparatus could generate a second sequence for each allocated symbol, and each symbol is associated with frequency domain resource units indicated by the corresponding second sequence. For another example, the transmitting apparatus could determine positions of frequency domain resource units for another symbol based on the second sequence, for example, the transmitting apparatus could perform shifting by a certain offset on the second sequence to obtain the positions of frequency domain resource units for another symbol.

In some embodiments, the M frequency domain resource units are associated with multiple symbols. For example, each symbol of multiple symbols is associated with the same M positions of the M frequency domain resource units. The transmitting apparatus could map the first sequence of reference signals to the M frequency domain resource units in each symbol of the multiple symbols.

The manner of the association relationship between the M frequency domain units and the one or more time domain units is not specifically limited in this application. For example, the first function (which is used to generate a second sequence) or the third function (which is used to generate a fourth sequence) could be associated with a certain symbol, and the positions of frequency domain resource units and antenna ports associated with other symbols could be defined by another function.

In some embodiments, the association relationship between M frequency domain resource units and one or more time domain resource units could be determined based on the third sequence (which is used to generate a second sequence). The property that sequence values are arranged in a certain order is utilized, a time domain resource unit may be associated with some sequence values at certain positions. For example, the first R sequence values in the third sequence constitute one subsequences #2 which is associated with the symbol with the smallest index, the next R sequence values in the third sequence constitute the next subsequence #2 which is associated with the symbol with the second smallest index, and so on, where the R may be equal to the ratio of M to R (Q=M/T). In some embodiments, the third sequence includes T subsequences #2, and the T subsequences of the third sequence are associated with the T time domain resource units. The M frequency domain resource units are divided into T frequency domain resource groups, and the T time domain resource units are associated with the T frequency domain resource groups, respectively.

For example, a third sequence {0.05, 0.44, 0.53, 0.84} includes two subsequences #2: {0.05, 0.44} and {0.53, 0.84}, where one subsequence #2 {0.05, 0.44} consisting of the first two sequence values in the third sequence is associated with symbol index 1, another subsequence #2 {0.53, 0.84} consisting of the next two sequence values in the third sequence is associated with symbol index 2. A second sequence {48, 57, 59, 67} is generated based on the third sequence, indicating 4 subcarriers, that is, subcarrier index 48, index 57, index 59, and index 67. The four subcarriers are divided into 2 frequency domain resource groups based on the way in which the third sequence is divided, that is, subcarrier index 48 and index 57 (which are indicated by the first two sequence values in the second sequence) constitute the first frequency domain resource group, which is associated with symbol index 1. Subcarrier index 59 and index 67 (which are indicated by the next two sequence values in the second sequence) constitute the second frequency domain resource group, which is associated with symbol index 2. In this embodiments, the positions of sequence values in the third sequence could be used to determine the association relationship between the M frequency domain resource units and one or more symbols, and the complexity of designing of reference signal pattern is reduced.

The way in which the third sequence is divided into multiple subsequences could be predefined or determined based on one or more parameters, such as the number of allocated time domain resource units and the value of M. This is not limited to this application.

The transmitter and the receiver could obtain the same second sequence, the transmitter could transmit the reference signals based on the second sequence, and the receiver could receive the reference signal based on the second sequence. That is, in some implementations, the transmitter and the receiver could perform the following at S530.

Optionally, at S530, the transmitting apparatus transmits reference signals to the receiver. Correspondingly, the receiving apparatus receives the reference signals.

The receiving apparatus could determine that a first sequence of reference signals is mapped to M frequency domain resource units on K antenna ports, and M positions of the M frequency domain resource units are indicated by a second sequence.

A description of the way to generate a second sequence, the way in which a second sequence indicates M positions of M frequency domain resource units, the way in which M frequency domain resource units are associated with K antenna ports, and the way in which the M frequency domain resource units are associated with one or more time domain resource units, were discussed in the description of S520. This will not be repeated here.

The transmitting apparatus could use the M frequency domain resource units to transmit the reference signals. The receiving apparatus could receive the reference signals, and perform signal measurement based on the determined M frequency domain resource units and the associated K antenna ports (which are antenna ports). Based on different uses, the receiving apparatus could perform different operations. For example, the receiving apparatus may perform correlation tests on the first sequence of reference signals and the received sequence of reference signals to obtain the corresponding measurements, such as but not limited: delay, received power, signal quality, etc. This is not limited in this application.

This application does not specifically limit the operation of the receiving apparatus side in receiving the reference signals. For example, when the receiving apparatus has multiple receiving antenna ports, the receiving apparatus could use all or part of the receiving antenna ports to receive the reference signal.

As mentioned above, the transmitting apparatus and the receiving apparatus could determine M positions of M frequency domain resource units by generating a second sequence at least based on a first parameter set and a third sequence. Optionally, before S510, the transmitting apparatus and the receiving apparatus could perform the following step at S540.

Optionally, at S540, the transmitting apparatus and the receiving apparatus obtain a first parameter set.

In some embodiments, all or part of the parameters in the first parameter set could be pre-configured on the transmitting apparatus side or receiving apparatus side. In some embodiments, one or more parameters are not pre-configured on the transmitting apparatus side or the receiving apparatus side. Accordingly, the transmitting apparatus could determine the parameter(s) and transmit the parameter(s) to the receiving apparatus, or the receiving apparatus could determine the parameter(s) and transmit the parameter(s) to the transmitting apparatus, or other apparatus (such as a core network apparatus) could determine the parameter(s) and transmit the parameter(s) to the transmitting apparatus and the receiving apparatus. This is not limited in this application.

The parameter(s) could be carried in various signals and different parameters could be carried in a same signal or in different signals. In other words, the transmission process of each parameter could be determined based on its application. For example, when requesting to access a network of the network device, the terminal device may transmit an access request to the network device. The access request carries the identifier of the terminal device. The network device may receive the access request transmitted by the terminal device, and obtain the identifier of the terminal device from the access request. For another example, the network device may configure bandwidth for the terminal device.

In some embodiments, the transmitting apparatus and the receiving apparatus may obtain a third sequence, a second parameter set (which is used to determine a relationship between a first parameter set and a second sequence), a first function (which represents the relationship between a first parameter set and a second sequence), or a third parameter set (which is used to determine the association relationship between M frequency domain resource units and K antenna ports) by a similar manner to that used to obtain a first parameter set. This will not be repeated here.

In this application, a second sequence could be generated based on a first parameter set, where the second sequence indicates M positions of M frequency domain resource units, and a first sequence of reference signals is mapped to the M frequency domain resource units, that is, in contrast to predefining positions of frequency domain resource units for the reference signals, the second sequence generated based on the first parameter set makes the determination of the positions of the frequency domain resource units more flexible.

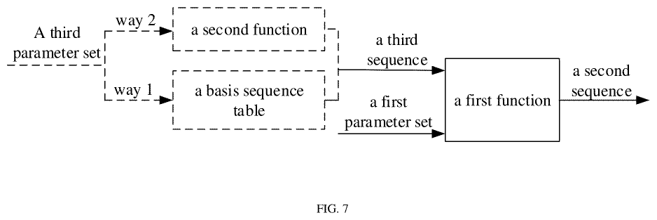

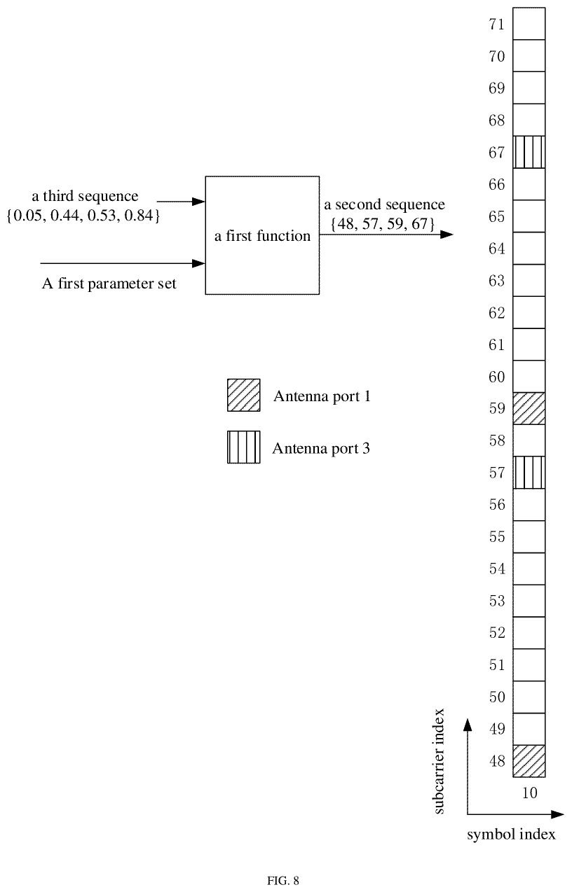

To facilitate the understanding of this application implementations, three examples are shown in FIGS. 8-10.

In a first example, FIG. 8 is the first schematic diagram of this application. A communication environment parameter and an identifier of a terminal device are used to select a third sequence among multiple pre-configured basis sequences. A threshold is equal to 4, which is determined based on the communication environment parameter, and the transmitting apparatus could determine that the number of frequency domain resource units used for reference signals is greater than or equal to 4, In this example, it is equal to 4. The transmitter could determine that the length of the third sequence is equal to 4, and could select one basis sequence based on the identifier of the terminal device among multiple basis sequences of length 4. For example, one basis sequence {0.05, 0.44, 0.53, 0.84} with index 1 could be selected based on a UE_ID equal to 001, and this basis sequence could be referred to as a third sequence, which is used to generate a second sequence. In this example, a first function sᵢ=└x*a┘+b−1, which is used to generate the second sequence, may be predefined, selected from a table, or received, and this is not limited in this application. A detailed description of this first function could be found above, and will not be repeated here. For example, a size of the bandwidth is used to determine that the number of the subcarriers in the bandwidth is equal to 24. A position of the bandwidth is used to determine that the index of starting subcarrier in the bandwidth is equal to 48. Thereby, the values of coefficients of the first function may be represented as {a=24, b=48, outputLength=4}, and the second sequence {48, 57, 59, 67} is obtained based on the first function. Two antenna ports with index 1 and index 3 are allocated to transmit the reference signals, a fourth sequence {1, 3, 1, 3} could be used to represent the association relationship between the four subcarriers and the two antenna ports. The fourth sequence could be generated in a predefined way, for example, the antenna port with the smallest index is associated with the subcarrier with the smallest index, the antenna port with the second smallest index is associated with the subcarrier with the second smallest subcarrier index, and so on. A symbol with index 10 is assigned to the reference signal, which is determined based on time domain information. That is, the four subcarriers are associated with the symbol index 10. Therefore, the first sequence of reference signals could be mapped to subcarrier index 48 and symbol index 10 on antenna port index 1, subcarrier index 57 and symbol index 10 on antenna port index 3, subcarrier index 59 and symbol 10 on antenna port 1, and subcarrier index 67 and symbol 10 on antenna port 3. For ease of description, a three-dimensional (a time-frequency-spatial domain) sequence could be used to represent resources positions in the time-frequency-spatial domain, for example, a three-dimensional sequence {10-48-1, 10-57-3, 10-59-1, 10-67-3} could be used to represent the example shown in FIG. 8. A three-dimensional sequence in the following description represents a similar meaning and will not be repeated.

In a second example, FIG. 9 is the second schematic diagram of this application. A communication between one receiving apparatus and two transmitting apparatus is illustrated in this example, where the receiving apparatus is the network device, and the two transmitting apparatus are two UEs which are represented as UE #1 and UE #2. The network device determines the pilot pattern for the two UEs respectively. For UE #1, the network determines that two symbols with index 10 and index 11 are allocated for reference signals. Density of the reference signals indicates that the number of subcarriers required for each symbol for the reference signals is 4. The identifier of UE #1 could be represented by UE_ID #1 equal to 001. A second function #1 is used to generate a third sequence #1 based on the above parameters, where the third sequence #1 could be represented as:

$$\{ [ \begin{matrix}1 , & 5 , & 8 , & 16 \\ 4 , & 10 , & 18 , & 24\end{matrix} ] \}$$

The third sequence #1 is in matrix form referred by 2-dimensional indexes with 1-dimensional index referred to symbols and 1-dimensional index referred to relative subcarrier indexes. In other words, the third sequence #1 includes 2 subsequences, which are {1, 5, 8, 16} and {4, 10, 18, 24}. The subsequence {1, 5, 8, 16} is associated with a symbol index 10, and the subsequence {4, 10, 18, 24} is associated with a symbol index 11. A position of the bandwidth #1 is used to determine that the index of starting subcarrier #1 in the bandwidth is equal to 48. A first function #1 is used to generate the second sequence #1 based on the above third sequence #1 and the above parameters, where the second sequence #1 could be represented as {48, 52, 55, 63, 51, 57, 65, 71}. The first four sequence values in the second sequence #1 are associated with the symbol index 10, and the last four sequence values in the second sequence #1 are associated with the symbol index 11. Two antenna ports with index 1 and index 2 are allocated to transmit the reference signals, a fourth sequence #1 {1, 1, 2, 2, 1, 1, 2, 2} could be used to represent the association relationship between the 8 subcarriers, 2 symbols and the 2 antenna ports. The fourth sequence #1 could be generated in a predefined way, this is not limited in this application. A three-dimensional sequence {10-48-1, 10-52-1, 10-55-2, 10-63-2, 11-51-1, 11-57-1, 11-65-2, 11-71-2} could be used to represent the example for UE #1 shown in FIG. 9.

For UE #2, network device determines that one symbol with index 10 is allocated for reference signals. Density of the reference signals indicates that the number of subcarriers required for one symbol for the reference signals is 6. The identifier of UE #2 could be represented by UE_ID #2 equal to 002. A second function #2 is used to generate a third sequence #2 based on the above parameters, where the third sequence #2 could be represented as {3, 11, 14, 17, 19, 24}. A position of the bandwidth #2 is used to determine that the index of starting subcarrier #2 in the bandwidth #2 is equal to 48. A first function #2 is used to generate the second sequence #2 based on the above third sequence #2 and the above parameters, where the second sequence #2 could be represented as {50, 58, 61, 64, 66, 71}. Three antenna ports with index 3, index 4 and index 5 are allocated to transmit the reference signals, and a fourth sequence #2 {3, 4, 5, 3, 4, 5} could be used to represent the association relationship between the 6 subcarriers, 1 symbol and the 3 antenna ports. The fourth sequence #2 could be generated in a predefined way, and this is not limited in this application. A three-dimensional sequence {10-50-3, 10-58-4, 10-61-5, 10-64-3, 10-66-4, 10-71-5} could be used to represent the example for UE #2 shown in FIG. 9.

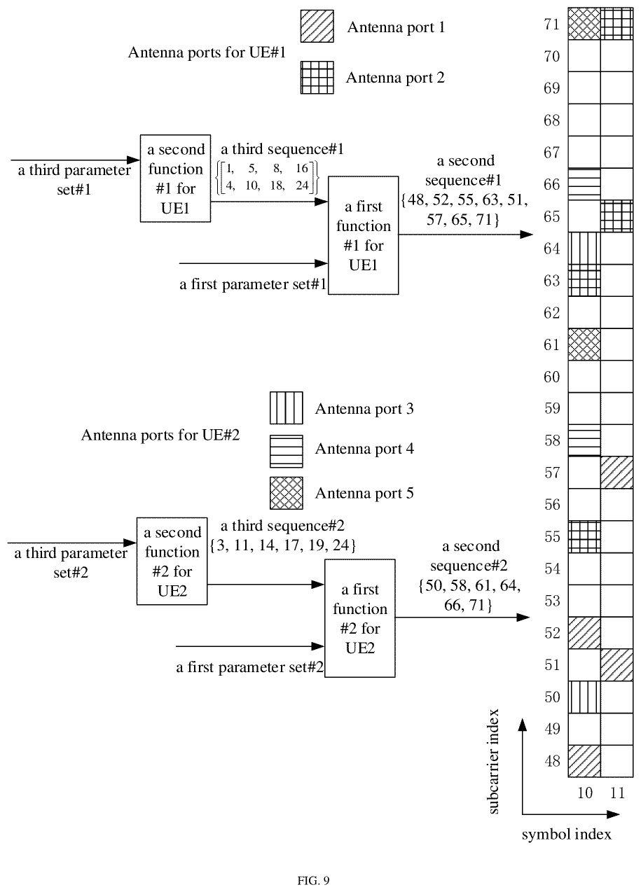

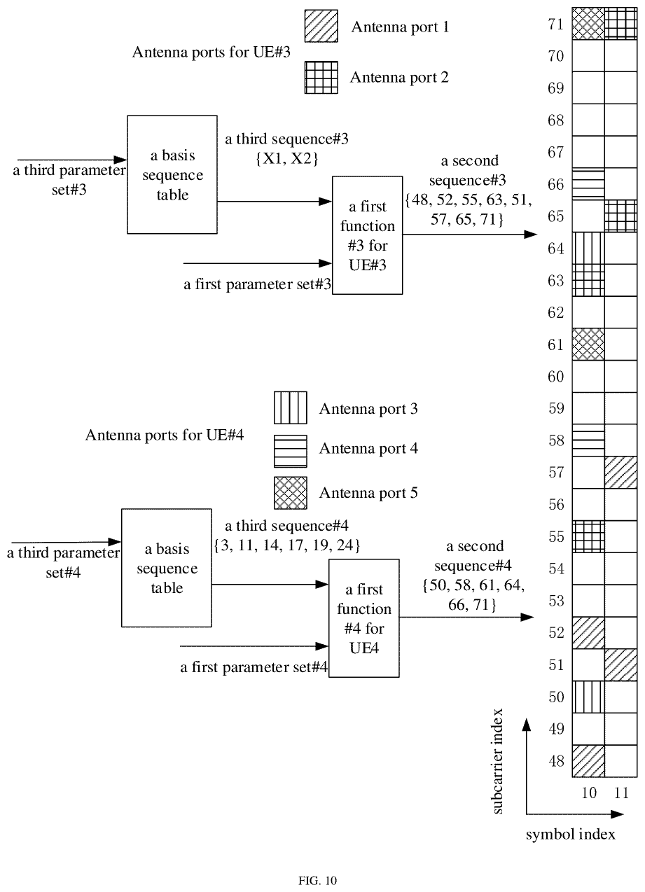

In a third example, FIG. 10 is a schematic diagram of a pattern based on a second sequence. A communication between one transmitting apparatus and two receiving apparatus is illustrated in this example, where the transmitting apparatus is the network device, and the two receiving apparatus are two UEs which are represented as UE #3 and UE #4. The network device determines the pilot pattern for two UEs respectively. For UE #3, the network device determines that two symbols with index 10 and index 11 are allocated for reference signals. Density of the reference signals indicates that the number of subcarriers required for each symbol for the reference signals is 4. The identifier of UE #3 could be represented by UE_ID #3 equal to 001. The transmitter could select two basis sequences for each of the two symbols, and the two basis sequences form a third sequence #3. As showing in FIG. 10, two basis sequences X1={1, 5, 8, 16}, X2={4, 10, 18, 24} could be selected as the input to the first function #3. The selected two basis sequences could have a similar meaning to the two subsequences of the third sequence #1 corresponding to UE #1 in FIG. 9. The subsequence X1={1, 5, 8, 16} is associated with a symbol index 10, and the subsequence X2={4, 10, 18, 24} is associated with a symbol index 11. A position of the bandwidth #3 is used to determine that the index of starting subcarrier in the bandwidth #3 is equal to 48. A first function #3 is used to generate the second sequence #3 based on the above third sequence #3 and the above parameters, where the second sequence #3 could be represented as {48, 52, 55, 63, 51, 57, 65, 71}. The first four sequence values in the second sequence #3 are associated with the symbol index 10, and the last four sequence values in the second sequence #3 are associated with the symbol index 11. Two antenna ports with index 1 and index 2 are allocated to transmit the reference signals, and a fourth sequence #3 {1, 1, 2, 2, 1, 1, 2, 2} could be used to represent the association relationship between the 8 subcarriers, 2 symbols and the 2 antenna ports. The fourth sequence #3 could be generated in a predefined way, and this is not limited in this application. A three-dimensional sequence {10-48-1, 10-52-1, 10-55-2, 10-63-2, 11-51-1, 11-57-1, 11-65-2, 11-71-2} could be used to represent the example for UE #3 shown in FIG. 10.

For UE #4, time domain information indicates that one symbol with index 10 is allocated for reference signals. Density of the reference signals indicates that the number of subcarriers required for one symbol for the reference signals is 6. The identifier of UE #4 could be represented by UE_ID #4 equal to 002. The transmitter could select a basis sequence {3, 11, 14, 17, 19, 24} from a sequence table based on the above parameters, where the selected basis sequence could be referred to as a third sequence #4. A position of the bandwidth #4 is used to determine that the index of starting subcarrier in the bandwidth #4 is equal to 48. A first function #4 is used to generate the second sequence #4 based on the above third sequence #4 and the above parameters, where the second sequence #4 could represent as {50, 58, 61, 64, 66, 71}. Three antenna ports with index 3, index 4 and index 5 are allocated to transmit the reference signals, a fourth sequence #4 {3, 4, 5, 3, 4, 5} could be used to represent the association relationship between the 6 subcarriers, 1 symbol and the 3 antenna ports. The fourth sequence #4 could be generated in a predefined way, this is not limited in this application. A three-dimensional sequence {10-50-3, 10-58-4, 10-61-5, 10-64-3, 10-66-4, 10-71-5} could be used to represent the example for UE #4 shown in FIG. 10.

The communication method according to the embodiments of this application is described in detail above with reference to FIGS. 5-10, and the transmitting apparatus and the receiving apparatus according to the embodiments of this application will be described in detail below with reference to FIGS. 11-15.

FIG. 11 is a schematic block diagram of a transmitting apparatus 10 according to an embodiment of this application. As shown in FIG. 11, the transmitting apparatus 10 includes:
a processing module 11, configured to generate a first sequence of reference signals; and
a transceiver module 12, configured to map the first sequence to M frequency domain resource units on K antenna ports, M positions of the M frequency domain resource units being indicated by a second sequence; where the second sequence is generated based on a first parameter set and a third sequence, and M and K are positive integers, M≥K.

Therefore, the transmitting apparatus could determine M positions of the M frequency domain resource units by determining the second sequence, and associate the M frequency domain resource units to the K antenna ports. The second sequence is generated at least based on a first parameter set, that is, in contrast to predefining positions of frequency domain resource units for the reference signals. Generating the second sequence based on the first parameter set makes the process of determining the reference signal pattern more flexible.

The transmitting apparatus 10 in this embodiment of this application may correspond to the transmitting apparatus in the communication method in the embodiments of this application described above, and the management operations and/or functions and other management operations and/or functions of modules of the transmitting apparatus 10 are intended to implement corresponding steps of the foregoing methods. For brevity, details are not described herein again.

The transceiver module 12 in this embodiment of this application may be implemented by a transceiver, and the processing module 11 may be implemented by a processor.

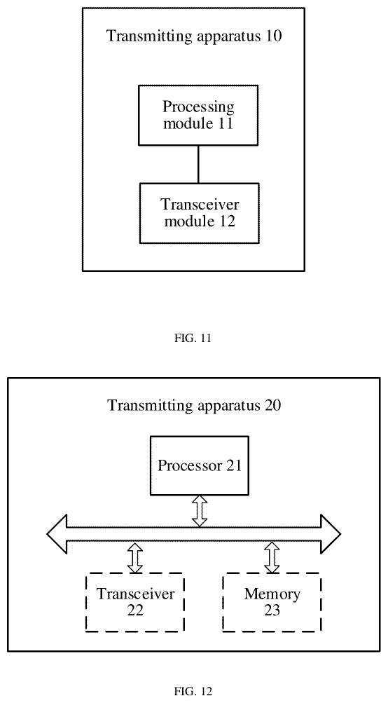

As shown in FIG. 12, a transmitting apparatus 20 may include a transceiver 21. Optionally, the transmitting apparatus 20 may further include a processor 22 and/or a memory 23. The memory 23 may be configured to store indication information, or may be configured to store code, an instructions, and the like that is to be executed by the processor 22.

FIG. 13 is a schematic block diagram of a receiving apparatus 30 according to an embodiment of this application. As shown in FIG. 13, the receiving apparatus 30 includes:
a processing module 32, configured to determine that a first sequence of the reference signals being mapped to M frequency domain resource units on K antenna ports; and
a transceiver module 31, configured to receive reference signals, a first sequence of the reference signals being mapped to M frequency domain resource units on K antenna ports, M positions of the M frequency domain resource units being indicated by a second sequence; where the second sequence is generated at least based on a first parameter set and a third sequence, and M and K are positive integers, M≥K.

The receiving apparatus 30 in this embodiment of this application may correspond to the receiving apparatus in the communication method in the embodiments of this application described above, and the management operations and/or functions and other management operations and/or functions of modules of the receiving apparatus 30 are intended to implement corresponding steps of the foregoing methods. For brevity, details are not described herein again.

The transceiver module 31 in this embodiment of this application may be implemented by a transceiver, and the processing module 32 may be implemented by a processor.

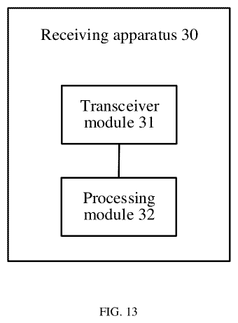

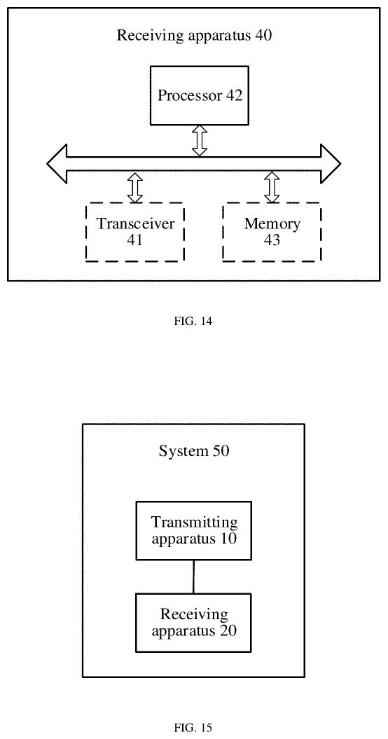

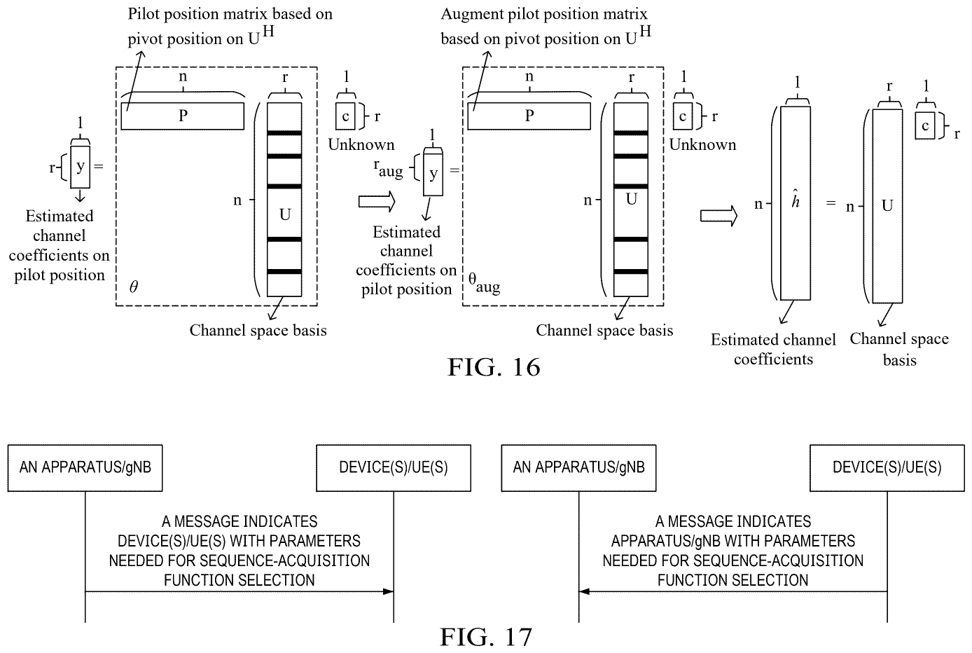

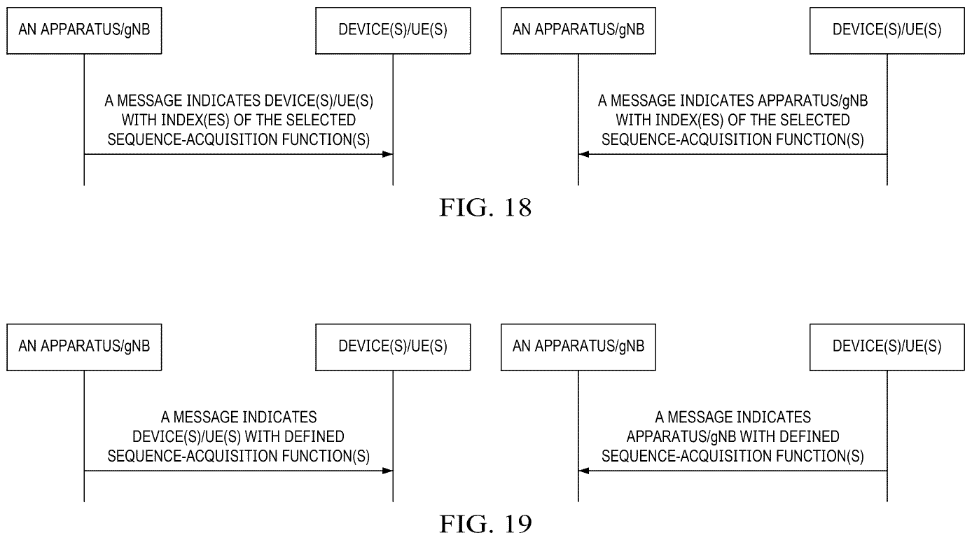

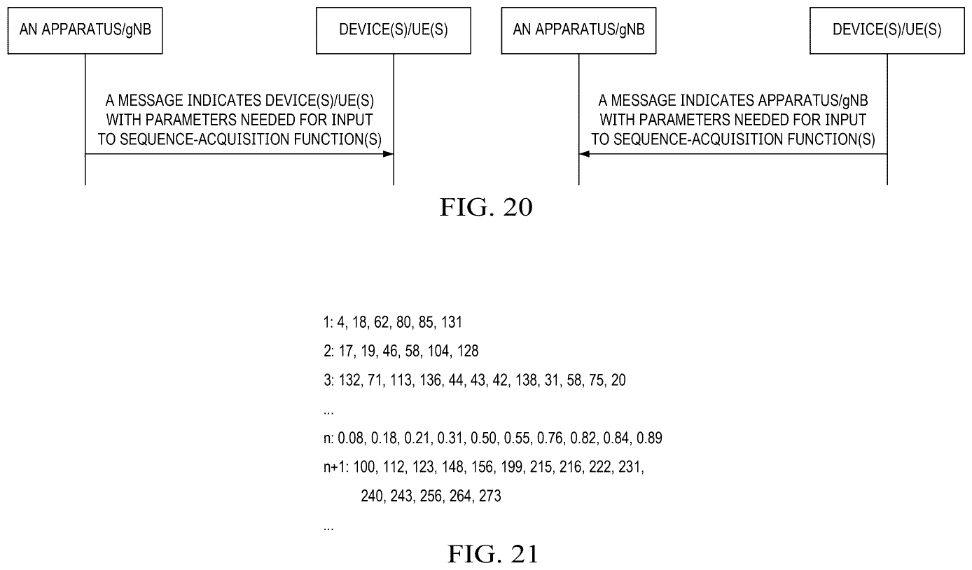

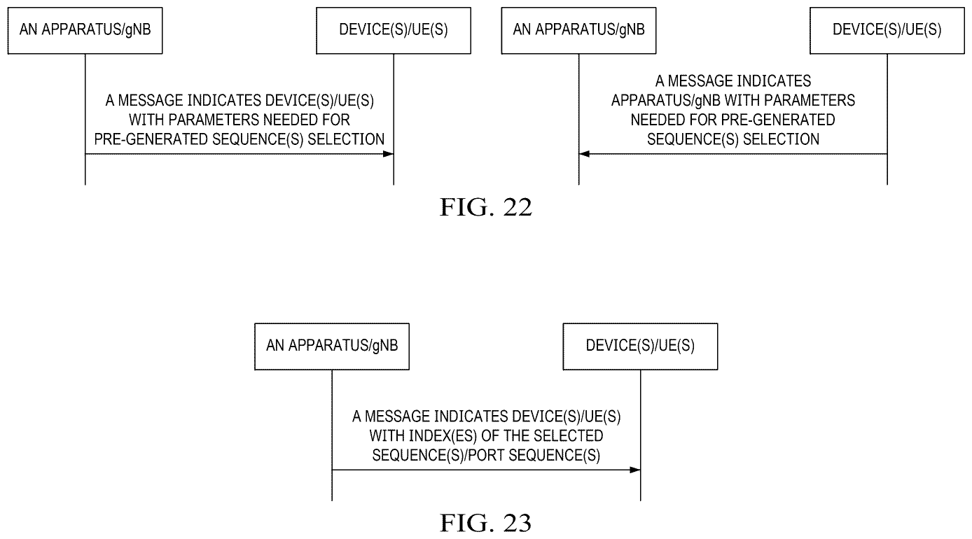

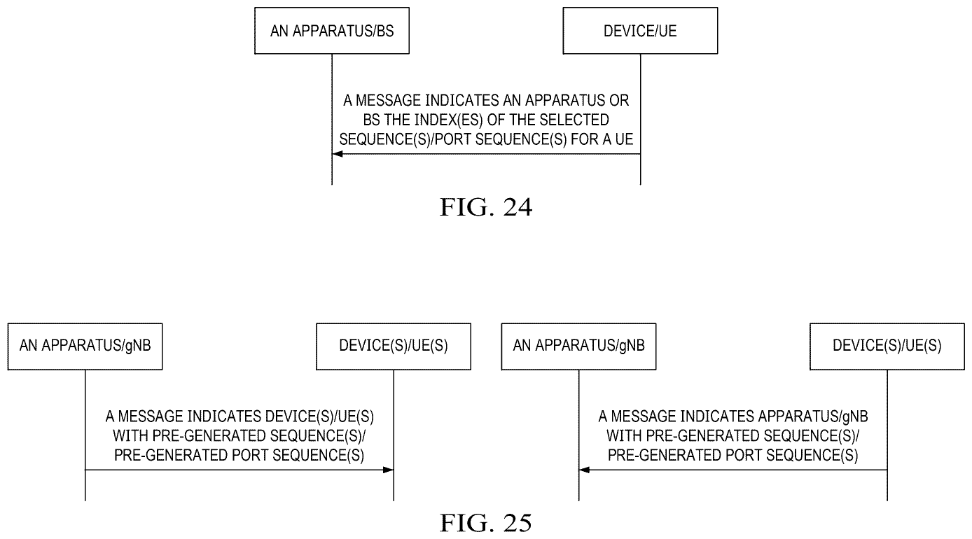

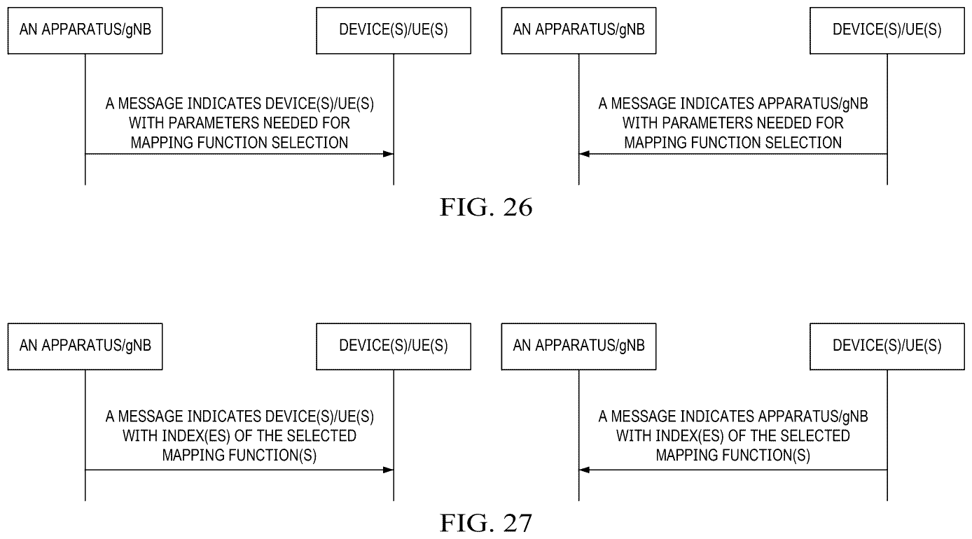

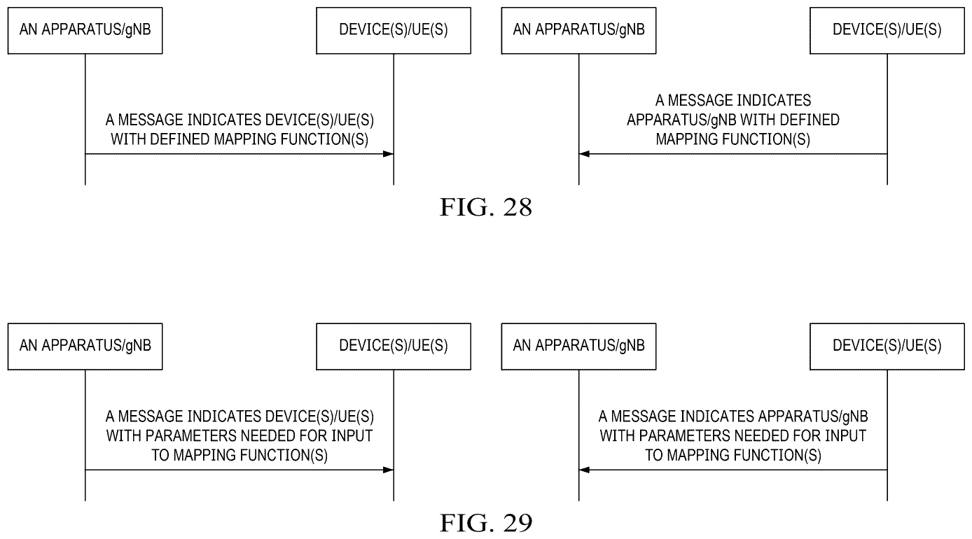

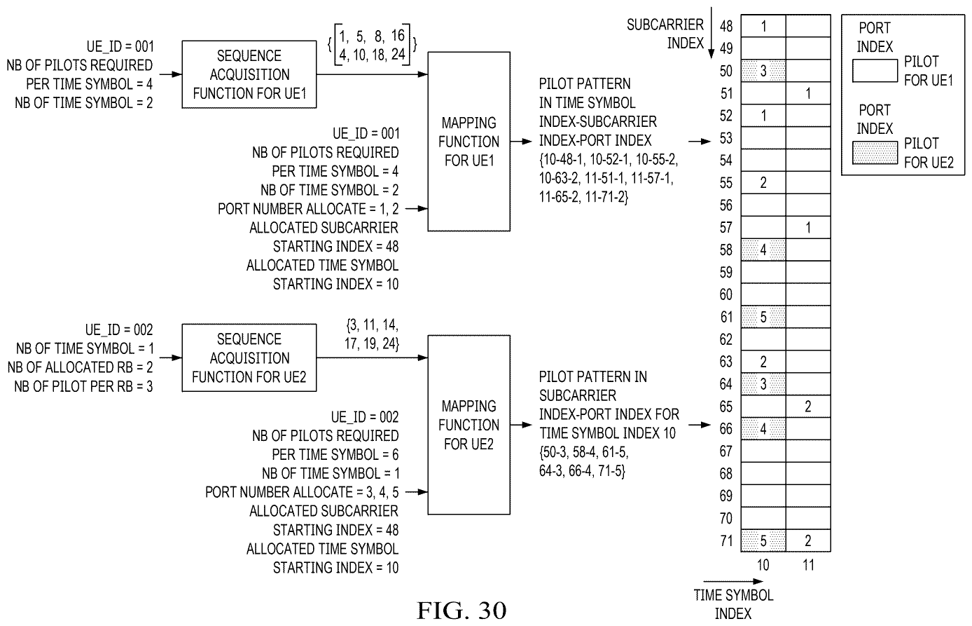

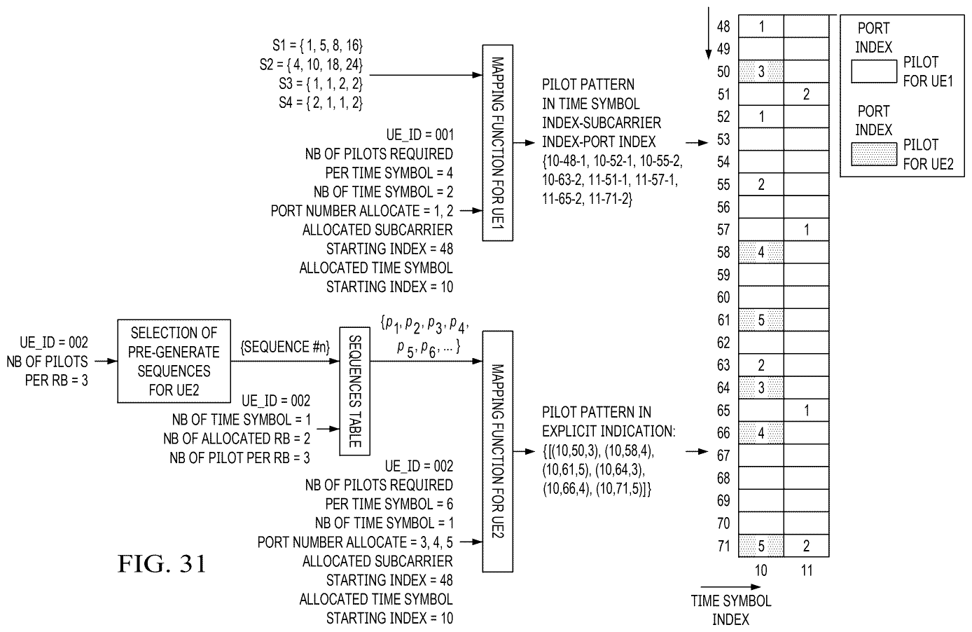

As shown in FIG. 14, a receiving apparatus 40 may include a transceiver 41. Optionally, the receiving apparatus 40 may further include a processor 42 and/or a memory 43. The memory 43 may be configured to store indication information, or may be configured to store code, instructions, and the like that is to be executed by the processor 42.

The processor 22 or the processor 42 may be an integrated circuit chip and have a signal processing capability. In an embodiment process, steps in the foregoing method embodiments can be implemented by using a hardware-integrated logical circuit in the processor, or by using instructions in the form of software. The processing module 21 may be a general-purpose processor, a digital signal processor (, DSP), an application-specific integrated circuit (ASIC), a field programmable gate array (FPGA), or another programmable logic device, a discrete gate or a transistor logic device, or a discrete hardware component. All methods, steps, and logical block diagrams disclosed in this embodiments of the present application may be implemented or performed. The general-purpose processor may be a microprocessor, or the processor may be any conventional processor or the like. Steps of the methods disclosed in the embodiments of the present invention may be directly performed and completed by a hardware decoding processor, or may be performed and completed by using a combination of hardware and software modules in the decoding processor. The software module may be located in a storage medium known in the art, such as a random access memory, a flash memory, a read-only memory, a programmable read-only memory, an electrically erasable programmable memory, or a register. The storage medium is located in the memory, and the processor reads the information in the memory and completes the steps in the foregoing methods in combination with the hardware of the processor.

The memory 23 or the memory 43 in the embodiments of the present invention may be a volatile memory or a non-volatile memory, or may include a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and be used as an external cache. Through example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synch Link DRAM, SLDRAM), and a direct rambus dynamic random access memory (Direct Rambus RAM, DR RAM). The storage of the system and the method described in this specification aim to include, but are not limited to, these and any other proper storage.

An embodiment of this application further provides a system. As shown in FIG. 14, a system 50 includes:
the transmitting apparatus 10 according to the embodiments of this application and the receiving apparatus 20 according to the embodiments of this application.

An embodiment of this application further provides a computer storage medium, and the computer storage medium may store program instructions for executing any of the foregoing methods.

Optionally, the storage medium may be specifically the memory 23 or 43.

A person of ordinary skill in the art will be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of this application.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in this application, the disclosed system, apparatus, and method may be implemented in other manners. For example, the described apparatus embodiment is merely an example. For example, the unit division is a logical function division and other methods of division may be used in an actual embodiment. For example, a plurality of units or components may be combined or integrated into another system, or some features may be ignored or not performed. In addition, the displayed or discussed mutual couplings or direct couplings or communication connections may be implemented by using some communication interfaces. The indirect couplings or communication connections between the apparatuses or units may be implemented in electronic, mechanical, or other forms.

The units described as separate parts may or may not be physically separate, and parts displayed as units may or may not be physical units, that is, the parts may be located in one unit, or may be distributed among a plurality of network units. Some or all of the units may be selected based on actual requirements to achieve the objectives of the embodiments.

In addition, function units in the embodiments of this application may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of this application may be implemented in the form of a software product. The software product is stored in a storage medium, and includes several instructions for instructing a computer device (which may be a personal computer, a server, a network device, or the like) to perform all or some of the steps of the methods described in the embodiments of this application. The foregoing storage medium includes any medium that can store program code, such as a USB flash drive, a removable hard disk, a read-only memory (ROM), a random access memory (RAM), a magnetic disk, an optical disc or the like.

The foregoing descriptions are merely specific embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method, comprising:
generating a first sequence of reference signals; and
mapping the first sequence to M frequency domain resource units on K antenna ports, M positions of the M frequency domain resource units being indicated by a second sequence; and
wherein the second sequence is generated at least based on a first parameter set and a third sequence, M and K are positive integers, and M≥K.

2. The method according to claim 1, wherein the first parameter set comprises one or more of the following parameters:
an identifier of a terminal device;
a density of the reference signals;
a size of a bandwidth, wherein the bandwidth comprises the M frequency domain resource units;
a position of the bandwidth;
a communication environment parameter;
time domain information indicating one or more time domain resource units associated with the M frequency domain resource units; or
spatial domain information indicating P antenna ports supported for the reference signals transmission, wherein P is a positive integer.

3. The method according to claim 1, wherein sequence values in the third sequence are selected from a value range, a ratio of a j-th sequence value in the third sequence to a size of the value range is related to a ratio of a j-th sequence value in the second sequence to a number of frequency domain resource units in a bandwidth, and the bandwidth comprises the M frequency domain resource units.

4. The method according to claim 1, wherein the third sequence comprises T subsequences, the T subsequences of the third sequence are associated with T time domain resource units, the M frequency domain resource units are divided into T frequency domain resource groups based on the T subsequences of the third sequence, the T time domain resource units are associated with the T frequency domain resource groups, respectively, and T is a positive integer.

5. The method according to claim 1, further comprising:
transmitting the first sequence to a receiving device.

6. A method, comprising:
receiving reference signals, a first sequence of the reference signals being mapped to M frequency domain resource units on K antenna ports, and M positions of the M frequency domain resource units being indicated by a second sequence; and
wherein the second sequence is generated at least based on a first parameter set, and M and K are positive integers, M≥K.

7. The method according to claim 6, wherein the first parameter set comprises one or more of the following parameters:
an identifier of a terminal device;
a density of the reference signals;
a size of a bandwidth, wherein the bandwidth comprises the M frequency domain resource units;
a position of the bandwidth;
a communication environment parameter;
time domain information indicating one or more time domain resource units associated with the M frequency domain resource units; or
spatial domain information indicating P antenna ports supported for the reference signals transmission, P is a positive integer.

8. The method according to claim 6, wherein sequence values in the third sequence are selected from a value range, a ratio of a j-th sequence value in the third sequence to a size of the value range is related to a ratio of a j-th sequence value in the second sequence to a number of frequency domain resource units in a bandwidth, and the bandwidth comprises the M frequency domain resource units.

9. The method according to claim 6, wherein the third sequence comprises T subsequences, the T subsequences of the third sequence are associated with T time domain resource units, the M frequency domain resource units are divided into T frequency domain resource groups based on the T subsequences of the third sequence, the T time domain resource units are associated with the T frequency domain resource groups, respectively, and Tis a positive integer.

10. The method according to claim 6, wherein the third sequence comprises K subsequences, the K subsequences of the third sequence are associated with the K antenna ports, the M frequency domain resource units are divided into K frequency domain resource groups based on the K subsequences of the third sequence, and the K antenna ports are associated with the K frequency domain resource groups, respectively.

11. An apparatus, comprising:
at least one processor coupled with at least one memory storing one or more instructions that are capable of being run on the at least one processor, and when the one or more instructions are run, the apparatus is enabled to:
generate a first sequence of reference signals; and
map the first sequence to M frequency domain resource units on K antenna ports, M positions of the M frequency domain resource units being indicated by a second sequence; and
wherein the second sequence is generated at least based on a first parameter set and a third sequence, and M and K are positive integers, M≥K.

12. The apparatus according to claim 11, wherein the first parameter set comprises one or more of the following parameters:
an identifier of a terminal device;
a density of the reference signals;
a size of a bandwidth, wherein the bandwidth comprises the M frequency domain resource units;
a position of the bandwidth;
a communication environment parameter;
time domain information indicating one or more time domain resource units associated with the M frequency domain resource units; or
spatial domain information indicating P antenna ports supported for the reference signals transmission, wherein P is a positive integer.

13. The apparatus according to claim 11, wherein sequence values in the third sequence are selected from a value range, a ratio of a j-th sequence value in the third sequence to a size of the value range is related to a ratio of a j-th sequence value in the second sequence to a number of frequency domain resource units in a bandwidth, and the bandwidth comprises the M frequency domain resource units.

14. The apparatus according to claim 11, wherein when the one or more instructions are run, the apparatus is enabled to:
transmit the first sequence to a receiving device.

15. The apparatus according to claim 11, wherein the third sequence comprises K subsequences, the K subsequences of the third sequence are associated with the K antenna ports, the M frequency domain resource units are divided into K frequency domain resource groups based on the K subsequences of the third sequence, and the K antenna ports are associated with the K frequency domain resource groups, respectively.

16. An apparatus, comprising:
at least one processor coupled with at least one memory storing one or more instructions that are capable of being run on the at least one processor, and when the one or more instructions are run, the apparatus is enabled to:
receive reference signals, a first sequence of the reference signals being mapped to M frequency domain resource units on K antenna ports, and M positions of the M frequency domain resource units being indicated by a second sequence; and
wherein the second sequence is generated at least based on a first parameter set, M and K are positive integers, and M≥K.

17. The apparatus according to claim 16, wherein the first parameter set comprises one or more of the following parameters:
an identifier of a terminal device;
a density of the reference signals;
a size of a bandwidth, wherein the bandwidth comprises the M frequency domain resource units;
a position of the bandwidth;
a communication environment parameter;
time domain information indicating one or more time domain resource units associated with the M frequency domain resource units; or
spatial domain information indicating P antenna ports supported for the reference signals transmission, wherein P is a positive integer.

18. The apparatus according to claim 16, wherein sequence values in the third sequence are selected from a value range, a ratio of a j-th sequence value in the third sequence to a size of the value range is related to a ratio of a j-th sequence value in the second sequence to a number of frequency domain resource units in a bandwidth, and the bandwidth comprises the M frequency domain resource units.

19. The apparatus according to claim 16, wherein the third sequence comprises T subsequences, the T subsequences of the third sequence are associated with T time domain resource units, the M frequency domain resource units are divided into T frequency domain resource groups based on the T subsequences of the third sequence, the T time domain resource units are associated with the T frequency domain resource groups, respectively, and Tis a positive integer.

20. The apparatus according to claim 16, wherein the third sequence comprises K subsequences, the K subsequences of the third sequence are associated with the K antenna ports, the M frequency domain resource units are divided into K frequency domain resource groups based on the K subsequences of the third sequence, and the K antenna ports are associated with the K frequency domain resource groups, respectively.
